(19) United States
(12) Patent Application Publication
(10) Pub. No.: US 2011/0112851 A1
(43) Pub. Date: May 12, 2011

(54) SYSTEMATIC PAYMENT AUDITING

(75) Inventor: Craig Poley, Colorado Springs, CO (US)

(73) Assignee: Nobelus, Inc., Colorado Springs, CO (US)

(21) Appl. No.: 12/617,533

(22) Filed: Nov. 12, 2009

(51) Int. Cl. G06Q 10/00; G06Q 50/00; G06Q 30/00

(52) U.S. Cl. 705/2; 705/30; 705/34

(57) ABSTRACT

A systematic audit of payment amounts for collections received for billed service is performed to identify payment discrepancies. Prices are assigned to service codes by government payers and private insurance companies with numerous variations. Each type of price model and variant is stored in a data repository. The price model may be categorized and applied per facility and per payer. Payment amounts are analyzed for price and billing code accuracy to determine whether the received payment accurately reflects the pricing model.

### RELATED APPLICATION

The present application relates to U.S. patent application Ser. No. 12/111,098 filed Apr. 28, 2008, attorney docket reference NOB001 which is hereby incorporated by reference in its entirety for all purposes as if fully set forth herein.

### BACKGROUND OF THE INVENTION

1. Field of the Invention

Embodiments of the present invention relate, in general, to the systematic auditing of payment amounts for provided healthcare and more particularly to systems and methods for systematically auditing and managing insurance company payments for provided medical services.

2. Relevant Background

In 1666, after what came to be known as “The Great Fire”, almost the entire city of London was left in smoldering ruins. In the fire's aftermath a number of laws and ordinances were passed that attempted to eliminate such devastation from future fires. One law allowed for the incorporation of an organization to indemnify for losses due to fire, thus setting the stage for the first insurance company.

In the year that followed, the first actual insurance company was formed, and included its own fully equipped fire-fighting teams to protect the buildings they insured. Other insurance companies formed and followed suit with their own fire brigades.

When a fire occurred, all the nearby fire brigades would rush to the building in case it was insured by their company. When the building was not insured by their company, the brigade members either left or, more likely, remained as observers. At best, the idea of insurer-owned fire departments was cumbersome; at worst, it was disastrous. The solution, of course, was to have municipal, not private, fire departments.

Fast forward some 350 years and consider the similar challenges of a medical professional or healthcare related business receiving compensation for the rendering of medical services. Medical billing is a growing challenge of healthcare management. At any given time, an Ambulatory Surgical Center (ASC) or similar medical facility can be working with and/or contracted with a hundred or more commercial insurance companies as well as numerous government agencies for the collection of payment for care services provided. Each insurance company and each government agency operates with a different billing system and format for payment. There is no uniformity or standardization. To tackle this almost insurmountable task, a typical ASC dedicates an entire department to identify and rectify payment problems. Most departments of this type focus their efforts around unpaid (aging) insurance claims and/or denials of payment for one or more reasons. An unpaid claim is one where the claim (invoice) has been submitted for payment, but no acknowledgement of the invoice or payment has been received. A denied claim is one where an acknowledgement has been received by the ASC but payment is lacking. Denials can be caused by one or more reasons including missing/invalid information, service not covered by a specific insurance policy, medical necessity, etc. The rules governing each policy for each insurance company are different.

Caught in-between an unpaid claim and a claim denial is a claim for which an improper payment was received. In many industries, once payment is received the account is considered closed regardless of whether the claim was paid in full or not. Indeed the mere fact of payment often outweighs the energy that would be expended in a collection attempt.

In healthcare, when services are rendered to an individual covered by an insurance policy, an outbound claim is issued to the insurance company stating the charges (amount due) as assigned by the care provider. These charges can be set to any amount and are seldom standardized. The outbound charge and how it is presented, however, may or may not have any ramification on the payment amount. With respect to ASCs, there are four main price models upon which a contract may be based: charge based, Medicare based, group based, or worker's compensation based.

Claims are comprised of a combination of insurance company information, patient information, and services rendered. Every service rendered at a healthcare facility (including an ASC) is denoted using a code designated to represent the service performed. While these codes are universal between healthcare providers, facilities, and insurance companies as to the type of service provided, the payment amount assigned to each code is not. For example an ASC may perform a simple surgical procedure classified under a particular set of codes. Depending on the individual's insurance company, and even the policy that the individual possesses, the “authorized” amount for any particular charge may differ. While simple in concept, the reality is anything but straightforward, and growing worse.

As is known to one of reasonable skill in the relevant art, some contractual agreements exist which base payments on a percentage of the charge (for example, 70% of billed charges will be paid). In exchange for a discount of the normal fee, the provider is given a reliable revenue source. These contractual agreements typically base payments on one of several different potential price models, but again, these models are not consistent. Moreover, a group of codes may exist for a particular procedure but the composition of the group may vary and/or the payment for each group may be different.

As is known to one skilled in the art, Centers for Medicare and Medicaid Services (CMS) (government based healthcare insurance for the elderly and underprivileged) have begun transitioning their ASC payments from an ASC-specific fee schedule (groups) to the hospital Out-Patient Payment System (OPPS). The applicable fee schedule is updated annually (with quarterly corrections). While the Medicare and Medicaid systems may drive insurance companies away from group billing procedures, many contracts with healthcare providers remain based on ASC payment groups to determine fees. In this model, similar medical codes are grouped into categories and these categories are assigned a payment amount. Commercial insurance companies maintain their own custom group lists and individually assign group prices per contract. Custom group lists are not generally set on a fixed annual update, but are instead updated according to the individual insurance company's preferences.

Under another billing model, some insurance companies enter into contracts with healthcare providers that include case rates for certain codes. A case rate is a fixed amount paid to the provider (ASC) for a certain type of medical treatment, regardless of how many codes (line items) are present on the claim or what those codes indicate.

Other insurance companies enter into contracts that arbitrarily limit the payable number of line items to a fixed number, each line item representing a separate medical procedure. When the claim has more line items than are payable per the contract, all additional line items beyond the contracted limit will be adjusted off (no payment may be collected from either the insurance company or from the patient). In addition, rules may apply to which line items are deleted.

Finally, some insurance companies apply non-standard discounts for multiple procedures—when multiple medical services (codes/line items) are provided to the same patient on the same date. It is generally accepted by the industry that multiple procedures receive payments that are reduced (discounted) by 50%, but some contracts apply custom discount rates or multiple discount rates for multiple line items.

Adding to the complexity of the medical billing practice is the concept of workman's compensation. Each state maintains an annual medical fee schedule to review and establish maximum allowable fees for healthcare services associated with workman's compensation related injuries. This fee schedule may be applied via contract or via payment network at face value or at a percentage thereof. For example, assume a state annually establishes its workman's compensation fee schedule. A surgical center may thereafter establish a contract with a workman's compensation network stating that the surgical center will accept a certain percentage of the workman's compensation schedule. In that way, the surgical center avoids dealing with the state to receive payment and, rather, accepts less than the total allowed amount in exchange for quick and reliable payment.

The evolution of the modern insurance system has resulted in a multitude of various payment models. Moreover, there are seemingly endless permutations of how any payment model can be implemented and applied by any given insurance company. A challenge exists not only to render a correct, accurate and optimal claim submittal but to correlate payments to those submittals. Most ASCs rely on one or more individuals and their experience to determine whether a claim is correctly coded and whether a payment correlates with a submitted claim. Such experience is inefficient, ripe with errors and inherently suboptimal.

When errors in payment are noticed, the same contracts which impose such coding complexities often make the appellate process cumbersome and time sensitive. Failure to either identify the problem within a specified time period or submit the proper correction documentation (in the form stipulated by the insurance company) means that the funds are lost. A need exists for a system to readily identify and, if need be, correct payment and coding problems so they can be addressed quickly and accurately. These and other challenges of the prior art are addressed by one or more embodiments of the present invention.

### SUMMARY OF THE INVENTION

A system and method for systematically auditing payments received for services billed by a service provider is disclosed hereafter by way of example. According to one embodiment of the present invention, payments received by a facility from a plurality of payers are compared against a plurality of pricing models to identify payment discrepancies. Each payment received by a facility is associated with a claim and each claim is associated with at least one billable line item. According to one embodiment of present invention, the payment received from a patient is thereafter associated with a pricing model having target payment amounts. An audit is conducted to compare an expected target amount for the at least one billable line item to the received payment amount. Discrepancies between the expected target amount and the actual paid amount are identified and presented to a user.

According to another embodiment of the present invention, an analysis of payment discrepancies is conducted to identify whether the payment discrepancy is justified. When a payment discrepancy is unjustified, the payment is highlighted to a user for corrective action. Embodiments of the present invention further assist a user to manage the corrective action. When a payment discrepancy is identified as justified, the pricing model is updated to reflect new claim payment data.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high-level diagram of a system for exporting and transferring data for systematic payment auditing according to one embodiment of the present invention;

FIG. 2 is a high-level flowchart that embodies a process for systematically auditing payments for services rendered according to one embodiment of the present invention;

FIG. 3 shows a detailed systematic flowchart embodying a process for auditing payments from insurance companies for medical services rendered in an ASC according to one embodiment of the present invention;

FIG. 4 shows a detailed systematic flowchart embodying a process for managing price models associated with medical services rendered maintained in a data store according to one embodiment of the present invention;

FIG. 5 comprises a plurality of screen shots showing a user interface for displaying and managing payment discrepancies identified through a payment audit system of the present invention; and

FIG. 6 shows a high-level diagram of a general computer system capable of implementing one or more embodiments of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### GLOSSARY OF TERMS

As a convenience in describing the invention herein, the following glossary of terms is provided. Because of the introductory and summary nature of this glossary, these terms must also be interpreted more precisely by the context of the Detailed Description in which they are discussed.

Cloud Computing is a paradigm of computing in which dynamically scalable and often virtualized resources are provided as a service over the Internet. Users need not have knowledge of, expertise in, or control over the technology infrastructure in the “cloud” that supports them. The term cloudy is used as a metaphor for the Internet, based on how the Internet is depicted in computer network diagrams and is an abstraction for the complex infrastructure it conceals.

HTTP (HyperText Transfer Protocol) is a communications protocol for the transfer of information on the Internet or a similar wide area network. HTTP is a request/response standard between a client and a server. A client is the end-user, the server is the web site. The client making a HTTP request—using a web browser, spider, or other end-user tool—is referred to as the user agent. The responding server—which stores or creates resources such as HTML files and images—is called the origin server. In between the user agent and the origin server may be several intermediaries, such as proxies, gateways, and tunnels. HTTP is not constrained to using TCP/IP (defined below) and its supporting layers, although this is its most popular application on the Internet.

A Web Server is a computer housing a computer program that is responsible for accepting HTTP requests from web clients, which are known as web browsers, and serving them HTTP responses along with optional data contents, which usually are web pages such as HTML documents and linked objects (images, etc.).

The Internet Protocol (IP) is a protocol used for communicating data across a packet-switched internetwork using the Internet Protocol Suite, also referred to as TCP/IP. The Internet Protocol Suite is the set of communications protocols used for the Internet and other similar networks. It is named from two of the most important protocols in it: the Transmission Control Protocol (TCP) and the Internet Protocol (IP), which were the first two networking protocols defined in this standard. Today's IP networking represents a synthesis of several developments that began to evolve in the 1960s and 1970s, namely the Internet and LANs (Local Area Networks), which emerged in the mid- to late-1980s, together with the advent of the World Wide Web in the early 1990s. The Internet Protocol Suite, like many protocol suites, may be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP model consists of four layers (RFC 1122). From lowest to highest, these are the Link Layer, the Internet Layer, the Transport Layer, and the Application Layer.

The Internet is a global system of interconnected computer networks that use the standardized Internet Protocol Suite, serving billions of users worldwide. It is a network of networks that consists of millions of private, public, academic, business, and government networks of local to global scope that are linked by copper wires, fiber-optic cables, wireless connections, and other technologies. The Internet carries a vast array of information resources and services, most notably the inter-linked hypertext documents of the World Wide Web and the infrastructure to support electronic mail. In addition, it supports popular services such as online chat, file transfer and file sharing, gaming, commerce, social networking, publishing, video on demand, teleconferencing and telecommunications.

### DESCRIPTION OF THE INVENTION

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

A system and method for systematically auditing treatment codes and the insurance company payments for medical services billed by an ASC or similar service facility is hereafter disclosed by way of example. Embodiments of the present invention examine payments received in response to codes submitted for a particular service(s) performed on a particular date. Depending on the contractual arrangement with the payer (insurance company), the submission of a claim for payment for the same type of provided service can vary widely. For example, if two individuals enter a medical facility at the same time with exactly the same condition and receive exactly the same treatment but possess different insurance carriers, the amount that the service provider will receive for the same provided service differs according to a particular contractually-agreed billing model. Payment depends on an accurate submittal of codes which identifies what type of services have been provided. Despite the same type of service being provided, the code submitted to differing insurance companies and how they are submitted may vary widely. It is of significant value for the service provider to accurately claim reimbursement for the services it has provided based on the criteria set by the appropriate insurance company, and to verify that the payment received matches the claim amount submitted. Variances in code submittals in response to payment discrepancies are examined and optimized by one or more embodiments of the present invention. The invention examines the amount of payment received from the payer to determine whether the amount received matches the claimed amount. If the received amount does not match the amount claimed, the payee is alerted of the discrepancy. Moreover the payment is scrutinized to determine whether the code submittal and corresponding payment were optimized for that particular payer.

According to another embodiment of the present invention, a plurality of pricing models is applied to one or more received payments to identify a matching price model for each payment. For the purpose of the present disclosure, a medical billing system is used as a primary application of the present invention. In such a system a medical service provider contracts with a plurality of insurance providers, each of which possesses different billing and coding requirements. A patient being seen at the medical facility is generally associated with one of these insurance providers and thus the service that is rendered is submitted to the appropriate insurance provider in accordance with that company's established procedures. One skilled in the art will recognize that the concepts disclosed herein can have broad applicability. Indeed the present invention can apply to any billing system involving a third party to perfect payment of services rendered. For example, body repair work of an auto from the result of a collision wherein the driver possesses an insurance policy may also find embodiments of the present invention applicable, albeit modified to reflect the automobile repair industry. The discussion of the present invention with respect to medical services should not and does not limit the applicability of the present invention. One skilled in the relevant art will recognize that the concepts presented and claimed herein can equally apply to a wide variety of applications involving the collection of fees from rendered services such as one involving multiple insurance companies or government agencies.

As is well known, a medical facility can hold contracts with a plurality of insurance companies. Because a single service provider such as an ASC can hold payment contracts with so many insurance companies, and since these insurance companies set the price for billed services independently of each other, there is no single consistent payment amount for any billed service. The medical billing system is further complicated by the fact that each insurance company typically provides a plurality of products (plans) which it offers to consumers. Each of these plans may provide for different coverage for the same medical procedure. These plans are changed frequently and often include inconsistent pricing information. Moreover, the pricing model contracted with an ASC may not reflect the most current pricing model of a particular individual plan. As one would expect, when a claim is submitted for payment, and when the line items associated with the claim are not precisely aligned with an existing payment plan, the insurance company may be faced with choosing between multiple, often conflicting, payment options; generally the insurance company picks the lowest possible payment.

According to one embodiment of the present invention, a system is disclosed that dynamically assigns an expected target price to every line item when payment is received at a facility, taking into account the line item billing code and insurance company's relationship with the facility. The contract rate can be based on any of several price models (percent of charge, groups, percent of Medicare, case rates, etc), and these stipulations are accounted for and priced accordingly.

Using this information, the present invention categorizes all audited (analyzed) payments as either a pass or failure. For the purpose of the present invention, a pass means the allowed amount (price)(that which the service provider receives for services rendered) equals the target amount (the claim submitted for reimbursement), while a failure indicates that the allowed amount is higher or lower than the target. Failures are further segmented into failure types. From such a segmentation a workflow management process is established to process these failures. The workflow management process enables the ASC to begin and manage the appeals (or similar) process for correcting faulty payments from the insurance company. In this manner, the ASC can actively address payment problems resulting in additional payments to the ASC and identify coding issues to proactively prevent them from occurring in the future.

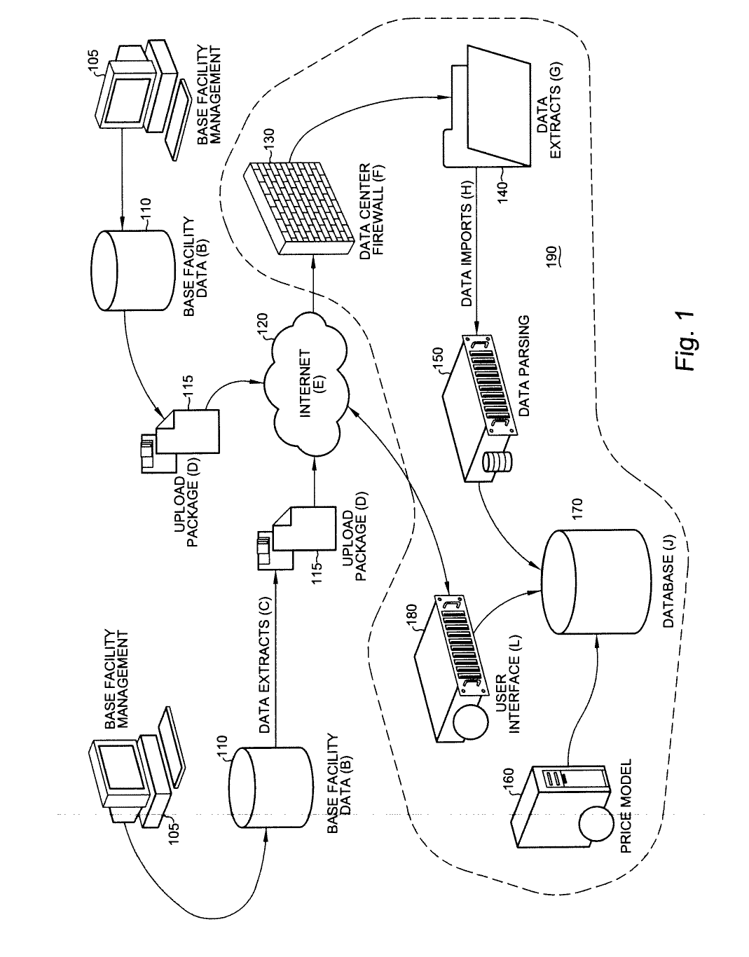

FIG. 1 is a high level diagram, according to one embodiment of the present invention, showing a computer based system that extracts data from a facility management module 105 and data storage unit 110 and then transfers or uploads 115 that data as a single file securely via a wide area network such as the Internet 120 to a data processing center 190 which then identifies anomalies in the billing/payment process.

The data passes through a data center firewall 130 and is thereafter delivered to a data extraction module 140 which disassembles the single file into its component delimited data files. The extracted data includes patient information, insurance information, line item coded transactions (billed, paid, written off), and price model data stored in the client's system. The data is thereafter parsed by a data parser 150 and integrated with various pricing models 160. A data storage device 170 retains the results which are later presented to a user via a user interface 180.

The system includes a facility Management Software Database having, among other things, a plurality of pricing models, a packaging process that combines all of the extracted data into a single file, an upload process that transfers the file to the data processing center, an unpackaging process that disassembles the single file back into its component delimited data files, a data parser, a set of tools for managing the various price models, a local data store and a user interface.

According to one embodiment of the present invention, the facility management database 110 located at an ASC, for example, is configured to export data periodically to delimited text files. These data files include pertinent claim and payment data to allow the present embodiment of the invention to audit the received payments and gain information, including codes for the type of services rendered and insurance company data. The data includes payment information regarding payments which a facility has received and pricing models under which the facility operates. As is shown in FIG. 1, the processing center receives via its web interface information from a plurality of facilities, each of which can provide to the processing center 190 payment and pricing model information. After the data has been exported to delimited files that reside on the facility management database 110, these files are packaged into a single compressed file. An upload process then makes a secure FTP connection to the processing center (via a certificate-authenticated SFTP link). Once the trusted connection has been established, the upload process transfers the compressed file to the server inside the processing center 190. When the compressed file exists in its entirety at the processing center 190, an unpackaging process extracts the multiple delimited data files from the compressed file. These delimited data files are then categorized by the data parsing server 150 and stored in the data store 170. As one skilled in the art will recognize, the data store may comprise multiple memory resources and data may be stored in separate physical or address locations to facilitate the auditing process. The data parser 150, after recording the base data in the data store 170, begins the analysis process (described herein). Upon gaining and storing the results of the audit process, the results are made available to the end user via a user interface 180 such as a web-based reporting tool.

As will be explained in more detail in subsequent sections, the auditing process of the present invention compares received payment data from a payer for a particular facility with that of pricing models known to exist between the facility and the payer. Once downloaded to the processing facility, the pricing models are maintained by the facility and thereafter validated during subsequent communications and audits.

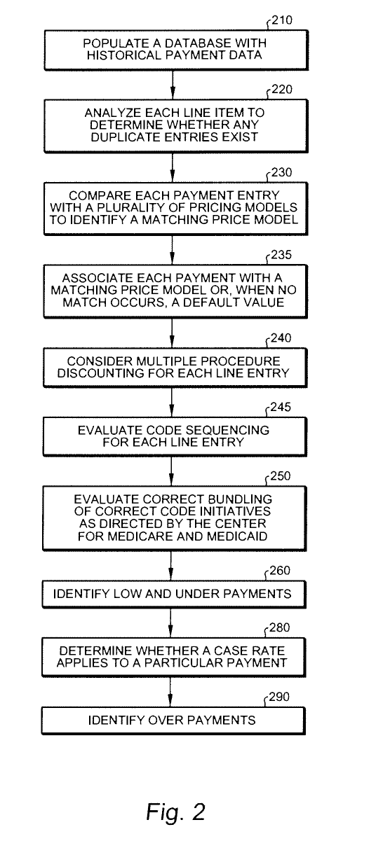

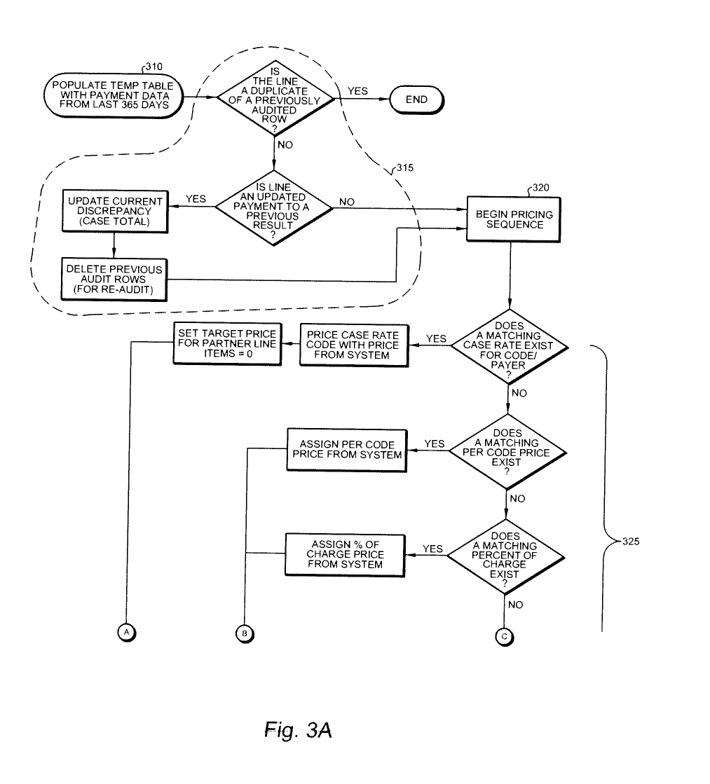

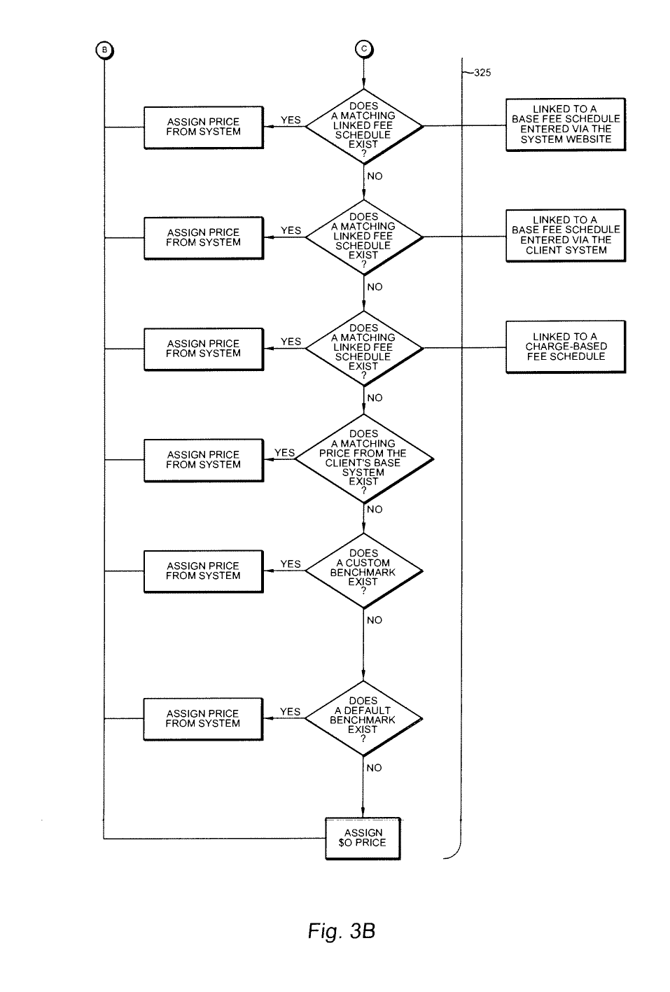

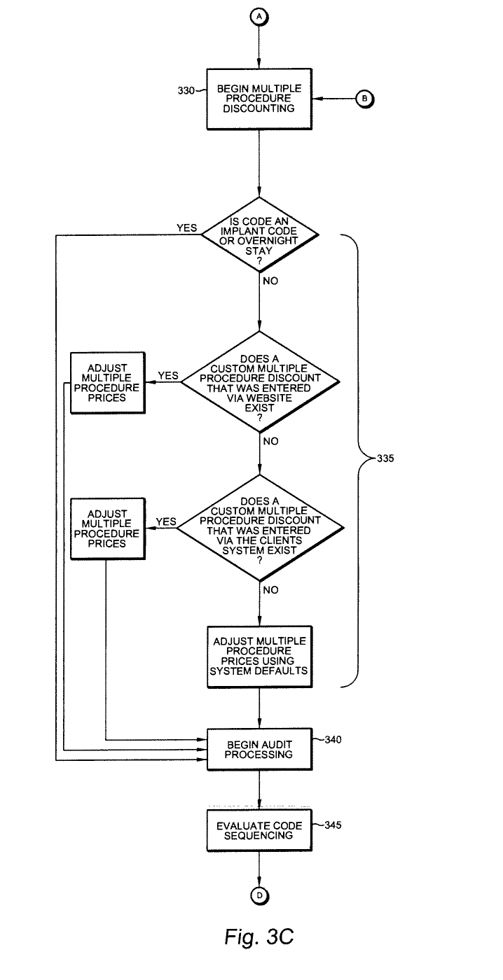

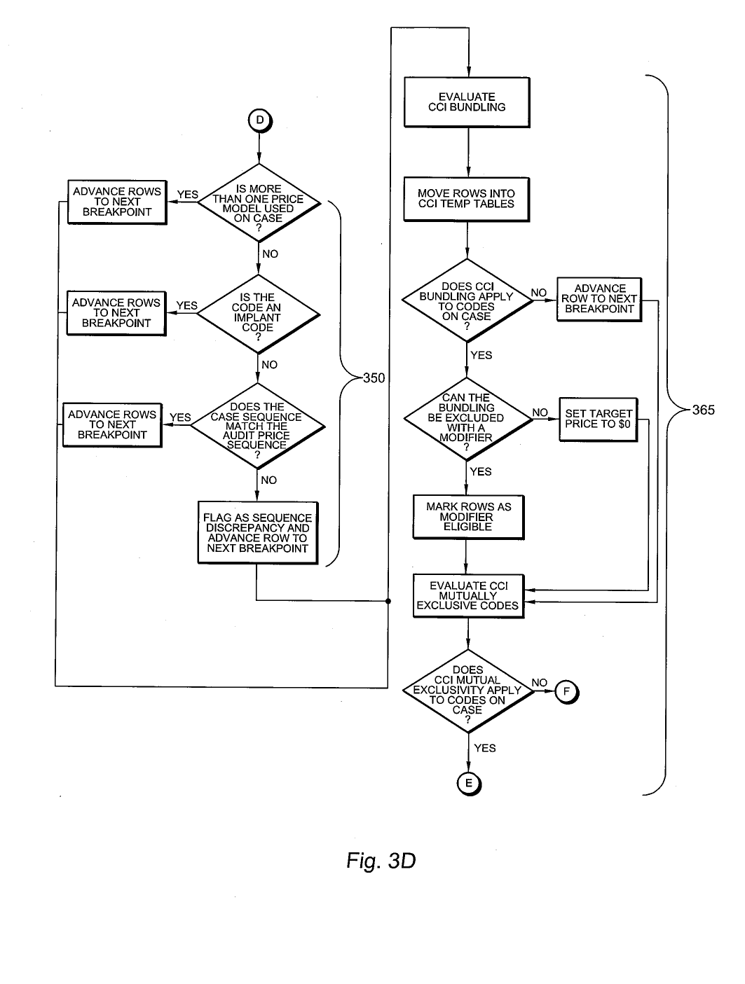

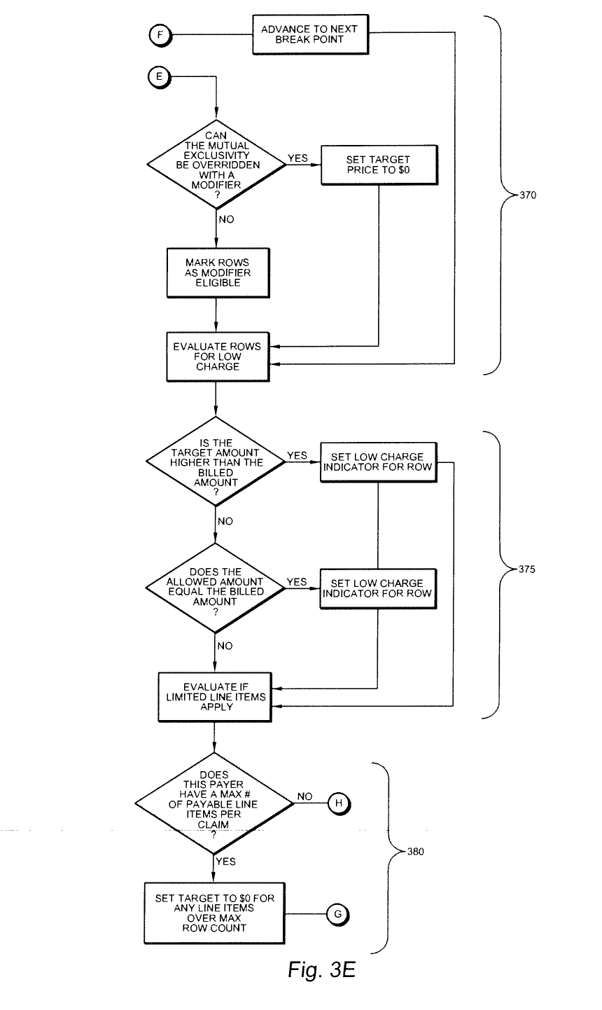

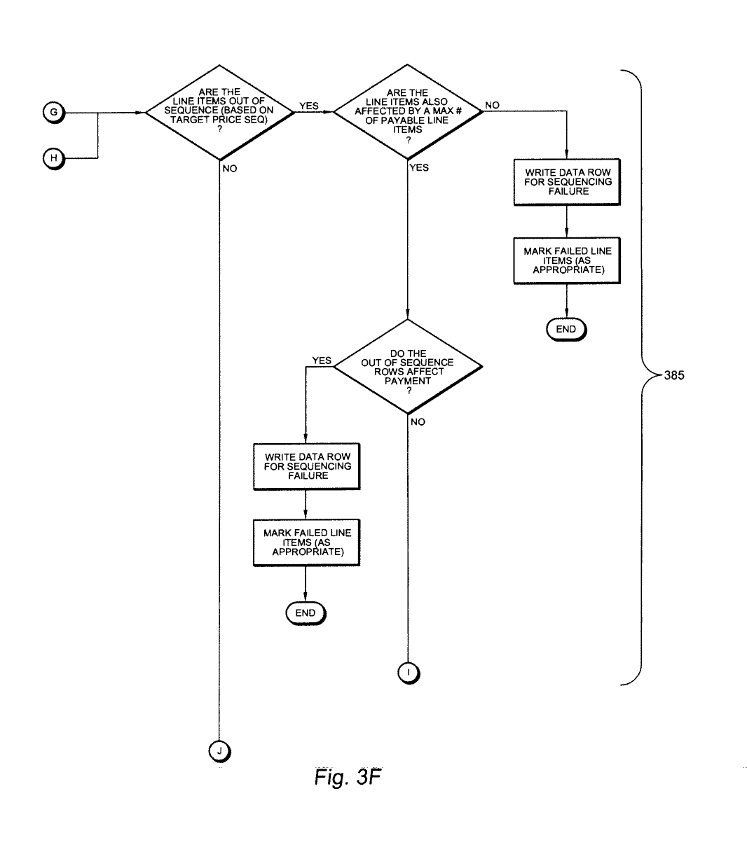

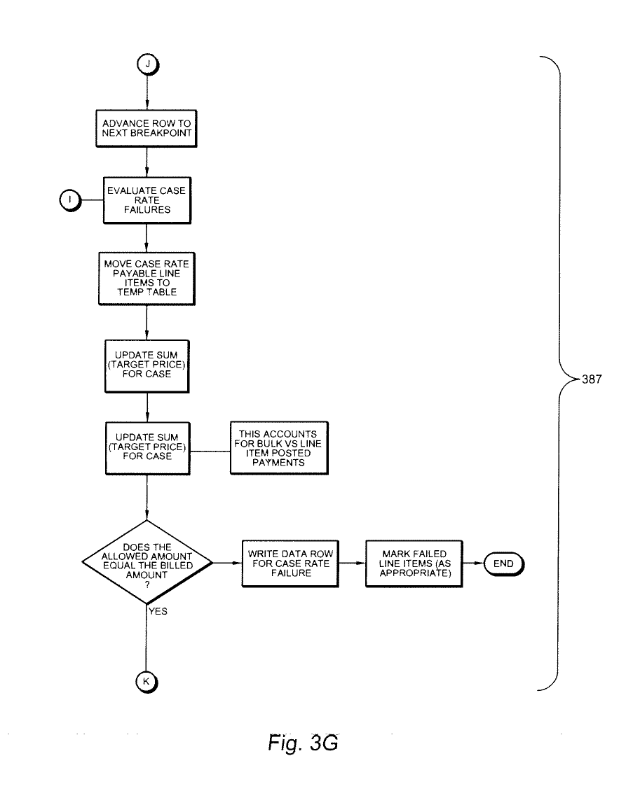

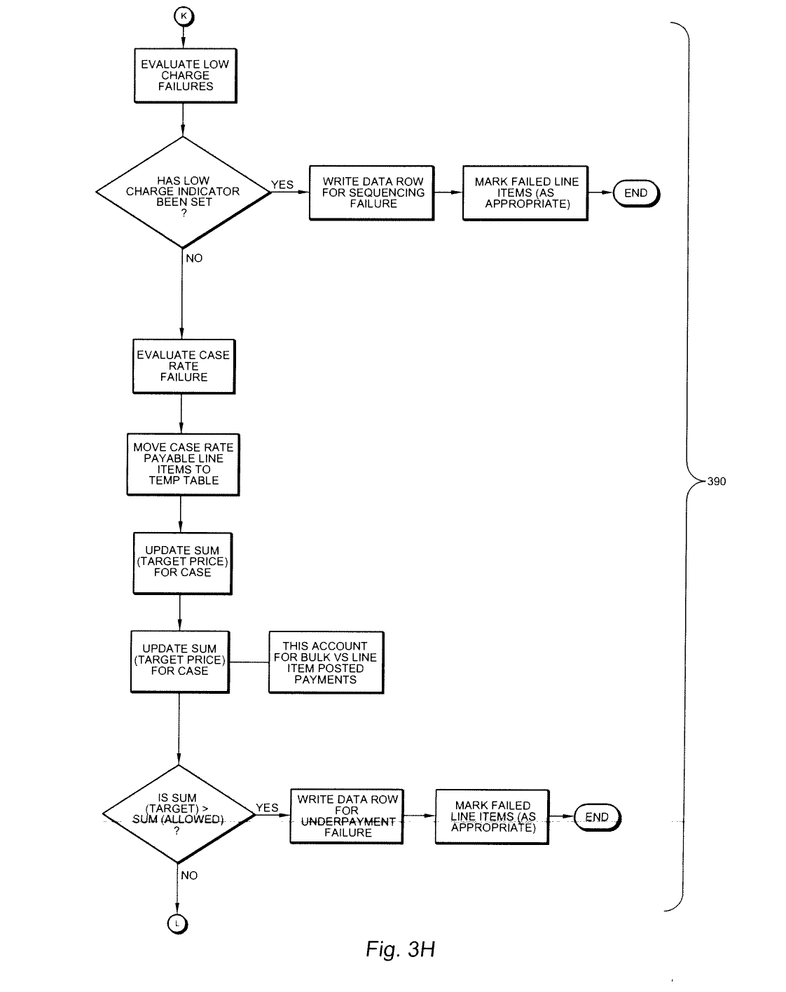

Turning in addition to FIG. 2, one method flowchart, according to the present invention, for analyzing collections gained from services provided in a disparate billing system is shown. FIG. 2 is a high-level flowchart of a process for auditing payments received for services rendered. A more detailed systematic flowchart for the auditing of payments received for medical services rendered as associated with insurance companies follows as FIG. 3. In the following description, it will be understood that each block of the flowchart illustrations presented herein can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations can be implemented by special purpose hardware-based computer systems that perform the specified functions or steps, or combinations of special purpose hardware and computer instructions.

To better understand the context of the present invention, consider a patient entering an ASC for treatment. The patient has engaged with a physician at the ASC to have a minor surgical procedure accomplished, for example the surgical repair of tennis elbow. The patient is further insured with a particular insurance carrier, Blue Cross/Blue Shield. Blue Cross/Blue Shield has numerous insurance plans, each of which has different pricing schedules. The ASC contracts with numerous insurance providers, of which Blue Cross/Blue Shield is but one. Assume the medical procedure takes approximately 4 hours and involves 15 particular line items for which reimbursement can be sought under the Blue Cross/Blue Shield contract. Each of these line items is coded and submitted to Blue Cross/Blue Shield for reimbursement according to the Blue Cross/Blue Shield contracted billing model. Thus a single claim is submitted, which is associated with 15 particular line items, each with a specific billing code.

Each billing code is associated with an amount charged for the services rendered. This value is likely higher than that which is contracted with Blue Cross/Blue Shield. As a result, there will be a write-off by Blue Cross/Blue Shield, ideally based on the existing contract between the ACS and Blue Cross/Blue Shield, to arrive at a payment amount. The reason that the amount charged for the services is typically higher than the contracted amount is because the ASC must set its prices to the highest allowed amount by all payers with which it contracts. If, for example, a contract existed that allowed a particular procedure to be reimbursed at $1000 but the claim was submitted for $900, the insurance company would only pay $900 even though the contract indicated that the agreed payment could be as high at $1000. And it is likely that the ASC would not be able to seek the additional $100 since the ASC is generally bound by its initial claim. Thus the ASC's cost is set at the maximum for all carriers. The ASC therefore uses a compilation of all contracted payer pricing schemes to ensure that a request less than that which is contracted is never submitted. As a result, most claims involve a write-off of some amount. The write-off is the difference between what the ASC to pay would charge an uninsured individual and what the insurance company has contracted with the ASC to pay for an individual it represents. The ASC cannot typically go back to the patient and seek the difference by virtue of the contract between the ASC and the payer. The present invention verifies that the write-off is accurate.

In the example presented above, Blue Cross/Blue Shield considers the claim, the policy of the individual with which the claim is associated and the contract in effect between Blue Cross/Blue Shield and the ASC and thereafter sends payment to the ASC. When the ASC receives a payment, it will be linked by the payer and the line items (billing codes) associated with that claim. For example, a claim may be submitted for $5000 for 3 line items; $1500, $1000 and $2500. The payment received may be for $2000 with instructions indicating that $900 is applied to item 1 with a $600 write-off, $500 is applied to item 2 with a $500 write-off and $600 is applied to item 3 with a $1900 write-off. However, as one skilled in the relevant art will recognize, many discrepancies can exist. The payment may not match that which is expected or the number of line items (billing codes) associated with a claim may not be the same as when the claim was submitted. For example, perhaps based on the existing contract in the above scenario, the ASC expected to receive for the $5000 claim an amount of $2200 in which the write-off of item 3 is only $1700 instead of $1900, or perhaps the received payment only recognized (and paid for) two of the three line items. These and other inconsistencies and their management are addressed by embodiments of the present invention.

FIG. 2 begins when new payment data populates 210 the data store 150 via the unpackaging and data import process. The blocks shown in FIG. 2 denote pertinent data that is analyzed and applied during the parsing of the audit data. Each line item of the data is analyzed 220 to determine whether a duplicate entry may exist. Once the accuracy of the data field is assessed as being accurate, each line within that field is compared 230 to a plurality of pricing models to identify a matching price model. Considering the example above, payment data from Blue Cross/Blue Shield may indicate a $6000 payment associated with a coded treatment for tennis elbow for John Doe. The present invention will compare the payment of $2000 to its understanding of what the ASC should have received for the coded payment to determine if it matches an established pricing model, realizing that the amount claimed and the amount paid may differ but that the same pricing model has been applied, albeit differently.

Thereafter each line entry is associated 235 with a pricing model and a “target” price. When no such match occurs a default target value of $0 is used as a placeholder and indicator that no exiting pricing model appears to be aligned with the payment received. Next the present invention considers whether the pricing model involves multiple pricing discounts 240 and/or code sequencing 245. In each instance the payment price can vary widely based on how the codes are submitted (sequence) or whether a certain procedure, by contract, can only be associated with a certain maximum number of codes. For example perhaps the Blue Cross/Blue Shield contract limits a claim for tennis elbow repair to 15 codes, but when the code was submitted the clerk used (and expected payment for) 17 codes. 17 line items may have, indeed, been done during the medical procedure, but the contract specifies that only 15 codes can be submitted, and perhaps the payer only recognized and paid for 13 line items. The present invention would capture this type of discrepancy.

One consideration addressed by the present invention is the concept of fee bundling 250. The Center for Medicare and Medicaid outlines what type of fees can and cannot be bundled. Most, but not all, insurance companies follow these guidelines. The present invention investigates if such bundling of fees should be, or has been, applied correctly.

The present invention then undertakes an analysis of whether there was an underpayment 260 or an overpayment 290. In undertaking this final analysis the present invention also makes an inquiry whether a particular case rate applies 280. As will be described in more detail with reference to FIG. 3 below, a case rate is a fixed amount which is applied to a coded item regardless of how many items are coded or the particular sequence of the line items. These and other aspects of the invention are described in detail below in the context of an ASC billing system.

FIG. 3 shows a detailed systematic flowchart embodying a process for auditing payments from insurance companies for medical services rendered at an ASC according to one embodiment of the present invention. Following the same general format as the process described in FIG. 2, the process shown in FIG. 3 provides specific detail of a payment auditing system for an ASC dealing with 7 different pricing models.

When new data is received, such as payment associated with a particular service, the data is written to temporary tables 310 where it can be analyzed and updated prior to being re-written to permanent tables in the data store. The embodiment of the present invention shown in FIG. 3 includes payment data from the past 365 days (the payment date is compared to the current date for this determination). The rows in the temporary table are evaluated to determine 315 if they are accurate, that is, if duplicate rows from existing audit results exist. If the row is found to be a duplicate, it is deleted from the temporary table and processing halts.

If the row is not found to be a duplicate, it is compared to current data to determine if it is a payment update to an existing data row. It is possible that the insurance company can authorize an additional payment or contractual write-off of an existing claim after rendering the initial payment, thus modifying the original entry. When the row of data is an update to an existing row, the previous discrepancy amount is updated to reflect the new payment or contractual write-off. Once the payment amount for that case has been updated, the existing data row is deleted so that it can be re-audited.

If the row is not found to be an update (meaning, it is a new payment or contractual write-off), then the row is ready to be audited. The auditing process of the present invention examines a myriad of details to determine whether a payment which has been received by an insurance company or similar payer matches that which was claimed by the service provider. The comparison requires the system to access detailed contractual information regarding which billing model is to be used and which codes within the billing model were submitted. Furthermore, modifications or updates to the model have to be considered. While conceptually the payer should either pay the claim as submitted or challenge the claim's validity/accuracy, it is increasingly likely that the payer simply submits a payment associated with a claim that does not match the claim and yet gives no basis for the difference. The reasons for such a discrepancy can be many, including simple errors in processing, computer glitches, updates to contracts by one party but not the other, etc. The first portion of the audit is the pricing sequence.

The pricing sequence 320, as indicated in FIG. 3, sequentially evaluates 325 every row for a matching price model for the applicable code/insurance company. A typical price model includes a list of codes and their corresponding prices. The prices could be derived from any ‘base’ fee schedule including but not limited to Medicare/Medicaid's annual fee schedule, a group model, workman's compensation, or even the original charge for services. This price model can carry additional stipulations such as case rates, carve outs (a code price that deviates from the ‘base’ rate and is usually higher), a max number of payable line items, or a custom multiple procedure discount model. The price exceptions can exist in a price model no matter what ‘base’ fee schedule is in play, so there are at least two sets of variables that can be applied independent of each other in any given contract.

The new rows of data in the temporary table are tested in their entirety one at a time against the criteria of each price model so as to ultimately associate 325 each row with a specific model. Recall that the pricing model associates a particular price with each coded service. The data which has been received includes, for a particular patient and service code, the amount that the insurance company is willing to pay. When a match is found, the appropriate price based on the model is assigned and the row is updated such that it is ready for the next processing sequence, multiple procedure discounting 330. If a match is not found, the remaining rows are tested for a match in the next price model until ultimately there is no matching price found for a code/insurance company combination. When this occurs, the row is assigned a price of $0 and advanced to the multiple procedure discounting analysis 330.

In the following paragraphs details with respect to each pricing model are discussed. In the embodiment shown in FIG. 3, 7 pricing models are examined as well as a default position of assigning a $0 value when no pricing model match has been found. One skilled in the relevant art will recognize that the number of pricing models may vary without departing from the scope and spirit of the present invention. The first price model that is evaluated for matching rows is a case rate. A case rate is a price assigned to a code where, if that code is billed on any claim, it will be paid at the case rate regardless of how many other line items were billed. For example, if you have a case rate for code 12345 and code 12345 appears on a claim, it does not matter if it is the only code on the claim or if there are 10 other line items, the ASC will receive only the agreed payment for code 12345. By comparison, some models consider different payment rates when one code is associated with another code. This model is updated via the user interface attached to the invention's data store. Through this interface, users can assign a case rate for any code/insurance company/facility combination. Case rates differ from other price models in that when a code is assigned a case rate, it does not matter what other codes are present on the claim (aggregating all billed services into a single invoice)—the entire claim is paid at the amount of the case rate. Since this price model differs so significantly from other price models, it is, in this embodiment, processed first.

When a matching case rate is found, that row is updated with the case rate price amount. Then the other codes that are present on the claim are assigned a target price of $0 (since no payment is expected for these codes). For example, referring to the previous example of a tennis elbow case, say that code 24360 (reconstruct elbow joint) had a case rate stipulated in the Blue Cross/Blue Shield contract that indicated a case rate payment amount of $1500. If this code was used on the claim, then the expected payment amount for that claim would be $1500, regardless of the additional line items that were billed along with the 24360 code. So the $1500 price would be applied to code 24360 and all remaining line items would have a target price of $0. The case rate can be thought of as a flat billing rate for that particular procedure. Clearly there are advantages and disadvantages to this sort of billing. If complications occurred during the procedure resulting in more line item claims, and if the billing model allowed for line item claims, the total claim amount may be $2500. By contrast if the procedure was exceedingly easy, the real cost of the procedure may have only been $1000. In both cases since the contract stipulates a case rate for this particular type of procedure, the payment is $1500 regardless of the number of coded entries. The service provider takes a loss on the first case and a profit on the second. With the pricing model matching complete, matching rows and their sibling codes from each claim are advanced to the next processing sequence. Rows in which no suitable match was found in this price model are advanced to the next price model for evaluation.

The next price model that is evaluated for matching rows is a per code price type of model. A per code price is simply the price assigned to a certain code/facility/insurance company combination regardless of the manner in which this price was set by the insurance company. It is simply the price for the code with no additional logic required (as with case rates). For example, if Blue Cross/Blue Shield set the price for code 24360 at $1300, then this price would be applied during this step of the processing (and corresponding prices for the remaining line items on the claim would be similarly applied). This type of model is updated via the user interface attached to the invention's data store. Through this interface, users can assign a price for any code insurance company/facility combination. These prices are assigned and applied as a single price when the appropriate code/insurance company/facility combination is found. If a matching row is found, that row is updated with the price amount and the matching rows are advanced to the next processing sequence. All remaining rows with no suitable match from this price model are advanced to the next price model evaluation, percentage of charge amount.

A percentage of charge amount is another pricing model that is evaluated by this embodiment of the present invention. In this instance the present invention searches the rows of payments for rows matching a percentage of the claimed charge amount (assigned per code). Consider again the tennis elbow example. Assume the claim amount was $2000 but for Blue Cross/Blue Shield the existing contract for this type of service stipulates that only 80% of the charged amount will be paid. Thus the payment amount for this type of claim should be $1600. While this model is less common as a standard price model for most insurance companies, it is still in use. More often, this might be applied in an insurance company contract as a price exception for certain types of codes. For example, say that part of the tennis elbow repair required the use of a medical implant (perhaps a screw in the bone to help reattach a ligament). This implant might be billed with the generic implant code of L8699. The Blue Cross/Blue Shield contract might stipulate that the implant will be reimbursed at charge plus 10%. In this case, the percentage of charge that would be expected would be 110% or $2200.

This model can be updated via the user interface attached to the invention's data store when a discrepancy is noted. Through this interface, users can assign a price for any code/insurance company/facility combination based on a percentage of the charge/billed amount. These prices are assigned and applied as a single price when the appropriate code/insurance company/facility combination is found. If a matching row is found, then that row is updated with the price amount by multiplying the percentage that was entered by the user (as a decimal) to the billed amount.

Another price model examined by the present invention is a linked fee schedule. There are 3 versions of linked fee schedules, based on what is the base “type” of charge. In one version a linked fee schedule is based on a per code price entered through the user interface to the invention's data store. Once a per code price has been entered into the data store (or, more likely, a collection of per code prices), that code/price combination can be linked to additional insurance companies. A linked fee schedule applies a base fee to a previously entered price (in this step, the model that is evaluated is the per code price) associated with the insurance company that is linked to the base fee schedule. During the linking process a user selects one set of price data for a facility/insurance company combination and then selects the facility/insurance company to apply the base data (refer to FIG. 3 for additional details). Essentially, this means a user can enter a base fee schedule (such as a state worker's compensation fee schedule) one time and then link that base fee schedule to an unlimited number of other insurance companies.

Turning back to the tennis elbow example, assume that the injury occurred while working and a workman's compensation claim has been initiated. The state has indicated that a workman's compensation claim for tennis elbow is priced at $1000. Each insurance company uses this as the base fee and then links additional fees. The Blue Cross/Blue Shield insurance schedule links an additional $1000 to this type of claim meaning that the service provider should receive $2000. Thus if the audit shows the payment less than $2000 a discrepancy would be noted.

Optionally the user can apply a fee schedule adjuster (as a percentage). This adjuster can be any amount from 1% to 999% to the linked fee schedule. When fee schedules are linked, all codes and prices that have been entered for the base fee schedule will also be applied to the linked fee schedule. This price model is also updated via the user interface attached to the data store. During evaluation, linked fee schedule prices are assigned and applied as a single price when the appropriate code/insurance company/facility combination is found. The difference in a linked fee schedule is that price is applied while taking an adjuster into account. The adjuster is applied as a percentage to the base fee schedule price and the adjusted price is assigned to the row. For example, if the Blue Cross/Blue Shield contract was based on another base fee schedule (say, 160% of the Medicare fee schedule), you could link the Blue Cross/Blue Shield fee schedule to the Medicare base fee schedule using an adjuster of 160%. This extends the functionality of base fee schedules (Medicare's schedule) as they are entered into the invention's data store.

Another linked fee schedule is based on prices entered through the client's facility management module. Once a price has been entered into the facility management module (or, more likely, a collection of prices), those code/price combinations are linked to additional insurance companies within the invention. This version of the linked fee schedule applies a base fee schedule's previously entered price to a particular insurance company that is linked to the base fee schedule. During the linking process a user selects one set of price data for a facility/insurance company combination and then selects the facility/insurance company to apply the base data. This price model is again updated via the user interface attached to the data store. During evaluation, linked fee schedule prices are assigned and applied as a single price when the appropriate code/insurance company/facility combination is found just as a per code price is applied.

Linked fee scheduling can also be based on a percentage of the charge amount. In this instance, the base fee schedule would be the charge amount with a specific linked percentage (from 1%-999%) applied. This incarnation of the linked fee schedule allows a user to designate the charge amount as the base fee schedule and the associated insurance company will pay a percentage of the charge amount for any billed service. In this way the linked fee schedule differs from the percentage of charge price model (where the percentage of charge is applied to a single code). For example, the Blue Cross/Blue Shield contract can be based on 85% of the charge amount (for all codes), and the Blue Cross/Blue Shield fee schedule could be linked to the Medicare base fee schedule using an adjuster of 85%. This extends the functionality of the invention to apply a charge-based price to any billed code.

A model known as a custom benchmark price allows users to assign a custom failure price for any code/facility combination. This custom benchmark price enables a user to determine a constant failure price for any billed service. Said another way, this model allows a user to specify a predetermined price if no other price has been entered for a given code (and previously evaluated). These prices are assigned and applied as a single price when the appropriate code/facility combination is found. Turning back to the tennis elbow example, if a custom benchmark had been created for code 24360 in the amount of $1000, this means that any time that code was used (and a more applicable price could not be found), the target price would be set to $1000. In this example, if the 24360 code had been priced at $900 by Blue Cross/Blue Shield, this price would cause an audit failure since the coded $900 price is below the default custom benchmark price. However, if a matching row is found, that row is updated with the custom benchmark price amount.

The last price model that is evaluated is the system default benchmark amount. This model is not user-updatable. In the embodiment of the present invention, this price is the designated Medicare price for every code which is payable by Medicare for the year in which the billed service was provided. This price is stored in the data store. These prices are assigned and applied as a single price when the appropriate code/facility combination is found. For example, if no price had been entered for code 24360 in any of the previously listed price models (and despite the comprehensive nature of many insurance pricing models there are many medical service codes that are absent), the system benchmark would be applied. In 2009, the Medicare price for a tennis elbow surgical procedure, code 24360, is $1,113.05, so that price would be applied as the target price. If Blue Cross/Blue Shield had priced this code at anything less than the benchmark amount, the line would cause an audit failure.

If, after all of the aforementioned price evaluations, the present invention has been unable to apply a target price for any code, it is extremely unlikely that the code that was billed will be payable by any insurance company or government payer. Recall that the present invention not only looks for a match between the applicable insurance pricing model and the coded medical service performed, but also the facility at which it was performed. The insurance company pricing models possess codes for almost all procedures and are updated regularly, but all procedures that can be performed on a patient cannot necessarily be performed at a surgery center (or at least are not supported by the insurance companies to be performed at a surgery center) and some billing codes are simply not addressed by many pricing models. For example, an insurance company will likely not pay for a critical inpatient procedure (heart surgery) to take place at an ASC. The risk associated with such a procedure is high thus they would require a hospital with an intensive care unit, emergency services and a cardiac critical care center to be used or at least immediately available. ASCs are typically used for outpatient procedures, but an ASC can bill for an overnight stay as long as the stay is limited to generally 3 days. That does not mean, however, that an ASC is prohibited from submitting a code that is not authorized for payment at an ASC. Perhaps a patient, for various reasons, did stay for 4 days or that open heart surgery was performed at the ASC because it was an emergency situation in which the patient could not be moved.

Most of the medical industry adheres to Medicare's list of payable codes, even though individual insurance companies set the prices for these codes differently. When Medicare does not approve a code for payment in an ASC, it is unlikely that a commercial insurance company will approve that code. In such a situation, after all seven of the previous price models have been unable to apply a price, the system applies a price of $0 meaning that the authorized payment for the submitted claim is $0 and advances the row to the next processing sequence. This step concludes the pricing sequence in the present embodiment of the invention. Thus, barring exceptional circumstances, if an ASC does a procedure in violation of Medicare's policies which are supported by the contracted insurance companies, the ASC will not get paid for the procedure.

The embodiment of the present invention shown in FIG. 3 continues the audit by determining whether a multiple procedure discount 330 should apply. Standard in the healthcare industry is the concept of discounting of multiple procedures (i.e., additional services provided to the primary service). For example, using the 15 line items typical for the treatment of tennis elbow, the first code listed on the claim is considered the primary procedure. The remaining 14 line items are considered additional services incidental to the primary procedure and, as such, are eligible for multiple procedure discounting. Medicare uses a standard discount of 100% allowable amount for the first billed service and 50% of the allowable amount for billed services thereafter (with certain exceptions). Most commercial insurance companies adhere to Medicare's standard, but there are exceptions. According to one embodiment of the present invention, exceptions in the multiple procedure discount model are taken into account by incorporating multiple procedure discounting customizations.

Certain types of codes are not eligible for multiple procedure discounts. The present invention considers the multiple scenarios when multiple procedure discounts may or may not apply 335. For example, implants are consumable and have a fixed cost and, as such, do not have a discount applied to them. The multiple procedure discount applies price exclusions or overrides to the standard pricing model. However in some cases, such as with implants, there is an exclusion to the exclusion.

The multiple procedure discounting evaluation looks for rows that indicate the use of an implant or an overnight stay. These billed services are not subject to multiple procedure discounting, and, if matching codes are found, they are advanced to the next processing sequence. All remaining rows with no suitable match for this exclusion of the multiple procedure discounting step are advanced to the next evaluation.

The multiple procedure discounting evaluation step also looks for matching rows that have a custom multiple procedure discount schedule that has been entered directly through the client's facility management module. This multiple procedure discount rate is updated via the client's software and data is imported into the data store during the data export/import process. If a matching row is found, then that row's price is updated by multiplying the previously set price by the discount as a percentage.

Lastly the Medicare standard multiple procedure discount is applied to all remaining un-discounted rows. This multiple procedure discount rate is not user-editable. Remaining rows have their price updated by multiplying the previously set price by the discount as a percentage. Remaining rows are then advanced to the next processing sequence.

With a pricing model identified and any applicable discounts applied, and according to one embodiment of the present invention, the examination of the payment received as opposed to an optimal target amount begins. To maximize the payment amount to the ASC, codes should be ordered on the claim in descending price order. Thus the code sequence is examined 345 for each line entry. Simply, the code with the highest payable amount from the applicable insurance company should be listed first on the claim so as to ideally escape multiple procedure discounting. This is especially pertinent when the insurance company in question has a contract specifying a maximum number of payable line items. In this case, an ASC should make sure the codes with the highest payable price are listed first on the claim, otherwise codes with an inferior price will be paid in lieu of the codes with a superior price amount. In the present example, the tennis elbow procedure included only 15 line items. It would be trivial for one skilled in the art to recognize which coded procedure possessed the highest payable amount so that it would be listed first. However, in most instances there may be several hundred line item codes for any one medical service. Moreover, some of the service provided are related and overlap. It is extremely difficult, if not impossible, to identify within a plurality of codes which one should be listed first.

The practical difficulty in properly sequencing codes lies in the fact that these codes are ordered by a human. Humans are prone to error. According to one embodiment of the present invention, a process exists to evaluate 350 the sequencing of the codes on a claim with respect to a particular billing model. The existing submitted sequence is compared to an optimal sequence as determined by price for that set of codes/insurance company combination. Exceptions are noted and responsive to the existing sequence being different than the optimal code configuration, a notification is generated to alert the user that a suboptimal billing claim has been presented to the insurance company. Thus, one embodiment of the present invention not only determines whether the received payment matches the claimed amount, but also whether the claimed amount is an optimal submission.

The first evaluation during the code sequence process is to test if more than one price model has been applied to the line items on a claim during the pricing sequence. It is unreliable to make a code sequencing determination if some of the codes on a claim were priced according to accurate prices entered via the user interface, while other codes on the claim were priced according to the system default benchmark price because no price had been entered for that code. In this example, the codes priced via the per code pricing cannot be properly sequenced with the default benchmark codes, as the price models do not substantially compare. As a result, if more than one price model has been applied to line items on a single claim, then all line items on that claim are advanced to the next process sequence. If only a single price model has been applied to all line items on a single claim, then the line items from that claim are advanced to the next evaluation.

The presence of implants (consumable hardware or durable medical equipment that is used as part of a surgical case—for example, screws or plates used to secure hard or soft tissue) as part of a surgical case is again considered. Recall that implant codes are excluded from code sequencing because industry standards predicate that these codes be listed last on the claim. Next a test is performed to determine whether the claim sequence matches a sequence as assigned by price. Said differently, does the sequence of codes reflect a sequence as determined by price? To accomplish this, the rows in the temporary table are updated with a sequence integer for each line item on each case. Once each row has been updated with a code sequence designation, that designation is compared to the designation provided as part of the data from the Facility Management module (and transferred to the data store via the data export/import processes). If the code sequence is found to be a mismatch, the raw is identified as having a code sequence discrepancy and advanced to the next process sequence. If the row does not have a code sequence discrepancy, that line item is advanced.

The auditing process of the present invention continues by evaluating codes on a claim for Correct Coding Initiative bundling policies 360. The Centers for Medicare and Medicaid Services (CMS) developed the Correct Coding Initiative (CCI) to promote national correct coding methodologies and to control improper coding leading to inappropriate payment. The CMS developed standardized coding policies based on coding conventions. The intention of the CCI is to prevent improper payment when incorrect code combinations are reported. For example, a billed service should not fragment a coded procedure into component parts. If a physician performs an upper gastrointestinal endoscopy with biopsy of the stomach, the physician should report CPT code 43239 (Upper gastrointestinal endoscopy . . . ; with biopsy, . . . ). It is improper to unbundle this procedure and report CPT code 43235 (Upper gastrointestinal endoscopy . . . ; diagnostic, . . . ) plus CPT code 43600 (Biopsy of stomach; . . . ). The latter code is not intended to be utilized with an endoscopic procedure code. However, there are circumstances when it would be appropriate to unbundle certain code combinations. In the CCI policy manual, these combinations are identified as modifier eligible. If an appropriate modifier indicating a separate procedure on a separate part of the body is present, then the unbundled code is eligible for payment. One embodiment of the present invention analyzes CCI bundled codes from two perspectives. First, to assign an improperly unbundled target price to $0 (since no payment is appropriate for that code), but second, to determine if a properly unbundled code was improperly denied payment. If the code is modifier eligible and has a proper modifier (which shows that the code was properly unbundled), then the unbundled code should be paid by the insurer. Often, insurance companies will deny payment for a bundled code because they do not consider modifiers in their CCI evaluations. This type of payment denial can usually be overturned through appeal, if the error is identified. One embodiment of the present invention identifies this type of error and initiates procedures to correct the mistake.

The CCI bundling evaluation sequence 365 begins by moving rows from the temporary table into two additional temporary tables for CCI bundling comparison. One of these tables stores the primary billed service from each unique claim being reviewed. The other table stores the child codes (position 2 through n on the claim).

After the two temporary tables are populated, each claim is tested to determine if the CCI bundling policy applies to rows on that claim. If the CCI bundling policy does not apply to any row on a claim, then that claim and all accompanying rows are advanced to the next processing sequence. If the CCI bundling policy applies to any row on a claim, that claim and the applicable rows are advanced to the next evaluation.

If the CCI bundling policy applies to a row, the row is then tested to determine if the CCI bundling policy can be excluded from that row with the use of an appropriate modifier. If the row is modifier eligible and an appropriate modifier was used on the claim, the row is identified as modifier eligible in the present embodiment of the invention and advanced to the next processing sequence. If the row is not modifier eligible or if the row does not include an appropriate modifier, then the target price is reduced to $0 and the row is advanced to the next process sequence.

At this point in the processing sequence, the prices for all rows have been set and any price exclusions (such as multiple procedure and CCI policies) have been applied. The resulting price is the “target price” which is used for price evaluations throughout the remainder of the sequence.

The next process sequence begins evaluation of all rows for potential undercharges 370. ASCs, like many healthcare providers and facilities, have struggled to identify a reliable and repeatable methodology to set their charges. Most insurance company contracts include a clause in their contracts which stipulates that the provider or facility will accept the lesser of the billed charge or fee schedule amount. For example, this means that if an ASC submitted in error a billed charge of $1000 for a code for which the insurance company fee schedule allowed a payment of $1200, the ASC would collect only $1000. One embodiment of the present invention addresses this potential loss of revenue by comparing the billed amount to the target price as assigned previously during processing. Recall that the target price is the price that was set by one embodiment of the present invention after it had passed through all of the pricing and price exclusion processing. It is the amount that the ASC should rightly receive. Ideally, it would be the contract amount, less any applicable multiple procedure discounting, etc. If a charge amount is determined to be lower than the target price, the row will be identified to the user as such and highlighted for further processing. (note that it is possible that both an undercharge and an underpayment exist. The present invention recognizes both instances and takes appropriate action to correct these discrepancies)

The undercharge evaluation sequence 375 begins by comparing the billed charge amount to the target price amount. If the target price amount is found to be higher than the billed charge amount, the row is updated with a low charge designation and advanced to the next process sequence. If the row's target price amount is higher than or equal to the billed charge amount the row is advanced to the next evaluation as an overcharge 290 has occurred which may be to the benefit of the ASC.

The next evaluation compares the allowed amount (the price set by the insurance company) to the billed charge. If the allowed amount is less than the billed amount, the row is updated with a low charge designation and advanced to the next process sequence. If the allowed amount is greater to the billed amount, the row is advanced to the next process sequence without a low charge designation

The next process sequence, which applies to undercharges or low charges, evaluates rows where a maximum number 380 of payable line items may be applicable. These are claims sent to an insurance company where the contract stipulates that only n number of line items on a claim are eligible for payment. This process begins the failure processing portion of the sequence. To this point, the processing sequence has identified specific rows where extenuating circumstances may apply and target pricing has been updated appropriately. During this portion of the process, when a payment failure is encountered, the failure will be marked accordingly.

The limited line item evaluation sequence 385 begins by analyzing rows where an insurance company contract is in place limiting the number of payable line items. If the row does not have such a contract in effect then the row is advanced to the next evaluation. If such a contract is in place, then all rows over the maximum number of payable rows have their target price updated to $0.

The next evaluation determines if the payable line items are improperly code sequenced (according to target price) compared to the billed sequence. Thereafter the improperly sequenced line items are restricted by a maximum number of payable line items. If the line items are not affected by a maximum number of payable line items, then a data row is written in the invention's permanent data store indicating a claim failure. The line items that caused the claim failure are indicated in the permanent data table in the data store appropriately and the process is complete. Line items that met the failure criteria are then removed from the temporary table. If the line items are affected by a limited number of payable line items, and the sequencing discrepancy affecting claims with a maximum number of payable line items affected the payment amount, then a data row is written in the invention's permanent data store indicating a claim failure. The line items that caused the claim failure are indicated in the permanent data table in the data store appropriately and the process is complete. If the sequencing discrepancy affecting claims with a maximum number of payable line items did not affect payment, then the rows are advanced to the next evaluation.

In an ASC or similar setting, payments can be entered either by posting line item payments into the system or by posting a bulk check amount into the system. Operationally, either method meets the day-to-day requirements of the ASC. From a payment auditing perspective, obviously line item payment data is preferred but not required for the present embodiment of the invention. Embodiments of the present invention function and identify correctly and incorrectly paid claims regardless of the manner in which payment data is applied. When line item payments have been posted to the system, the present embodiment of the invention can additionally identify which individual line item(s) caused the audit failure. In order to evaluate either payment posting condition, case rate claims are examined 387 by moving them to an additional temporary table. This temporary table is updated to store a sum total of the target prices for the claim. This target price total amount is then compared to the total allowed amount for the claim. By comparing the sum values, the present embodiment of the invention is agnostic in regards to the manner in which payments are posted. If the target price total amount is greater than the total allowed amount, then a data row is written in the invention's permanent data store indicating a claim failure. The line items that caused the claim failure are indicated in the permanent data table in the data store (when line item payment data is available) and the process is complete. Line items that met the failure criteria are then removed from the temporary table. If the claim is paid correctly then the rows are advanced to the next evaluation.

The next evaluation determines if a low billed charge 390 amount affects any of the rows. If the low charge indicator has been enabled for any line items, the line items with the discrepancy are indicated in the permanent data table in the data store appropriately and the process is complete. Line items that met the failure criteria are then removed from the temporary table. Thereafter a determination is made whether the claims were underpaid. In order to test either payment posting condition (bulk or line item), claims are moved to an additional temporary table. This temporary table is updated to store a sum total of the target prices for the claim. This target price total amount is then compared to the total allowed amount for the claim. By comparing the sum values, the present embodiment of the invention is agnostic in regards to the manner in which payments are posted. If the target price total amount is greater than the total allowed amount, then a data row is written in the invention's permanent data store indicating a claim failure. The line items that caused the claim failure are indicated in the permanent data table in the data store (when line item payment data is available) and the process is complete. Line items that met the failure criteria are then removed from the temporary table. If the claim is paid correctly then the rows are advanced to the next evaluation.

Overpaid claims are also considered 392. To conduct such a test claims are moved to an additional temporary table. This temporary table is updated to store a sum total of the target prices for the claim. This target price total amount is then compared to the total allowed amount for the claim. By comparing the sum values, one embodiment of the present invention is agnostic in regards to the manner in which payments are posted. If the target price total amount is less than the total allowed amount, then a data row is written in the permanent data store indicating a claim failure. The line items that caused the claim failure are indicated in the data table in the data store (when line item payment data is available) and the process is complete. Line items that met the failure criteria are then removed from the temporary table.

Any line items remaining in the temporary table after the preceding evaluation are line items that have met all payment evaluation criteria 395. Rows remaining in the temporary table are indicated as having passed the audit and corresponding data flags are indicated as such in the invention's permanent data store. The evaluation process ends 399 and all temporary tables are cleared of any remaining data.

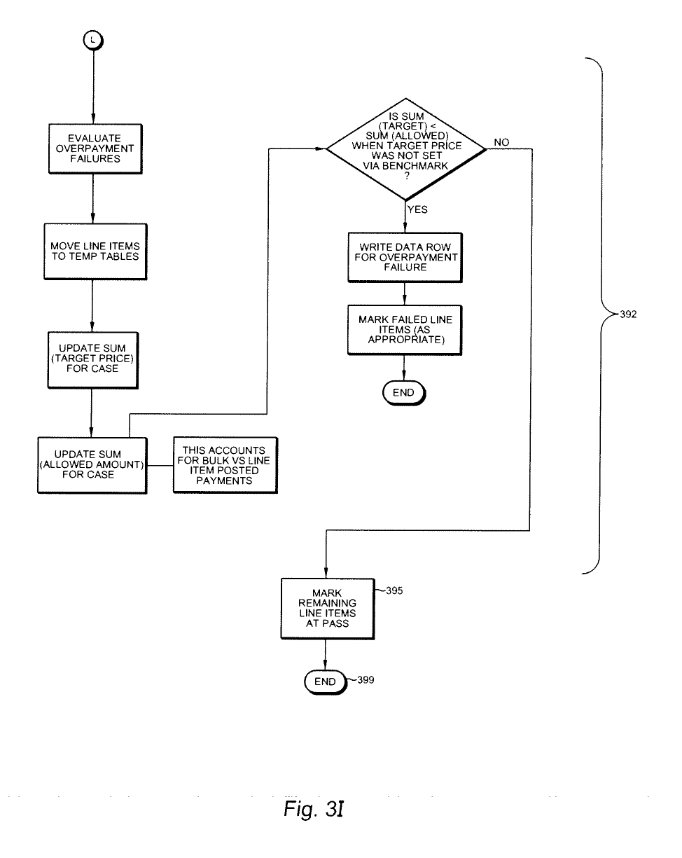

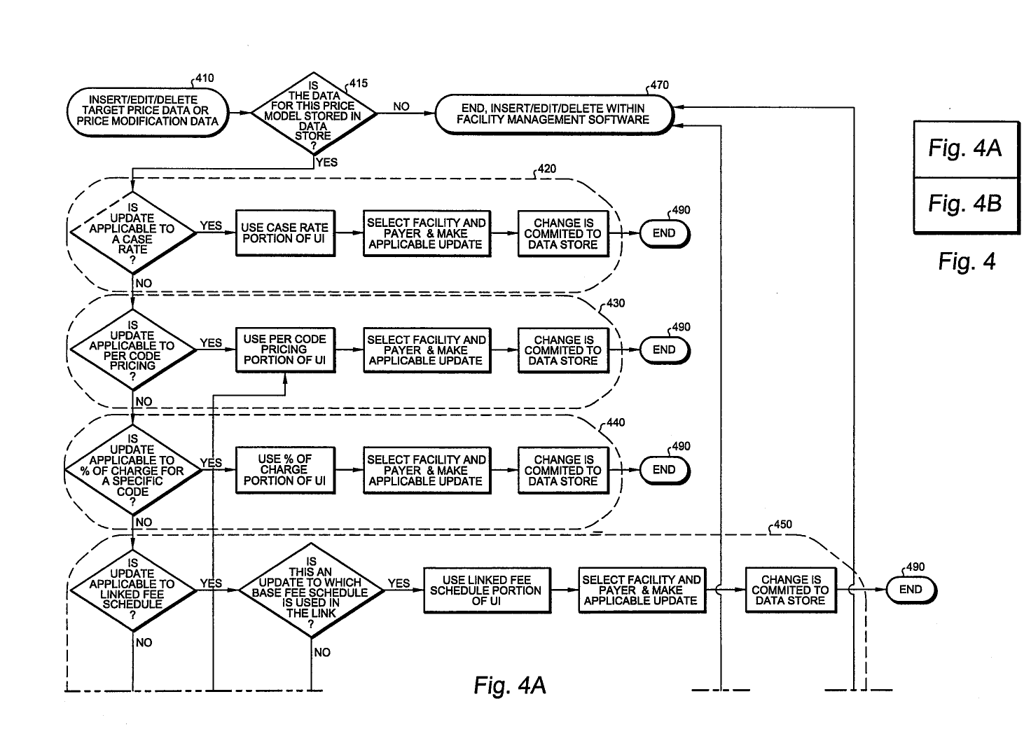

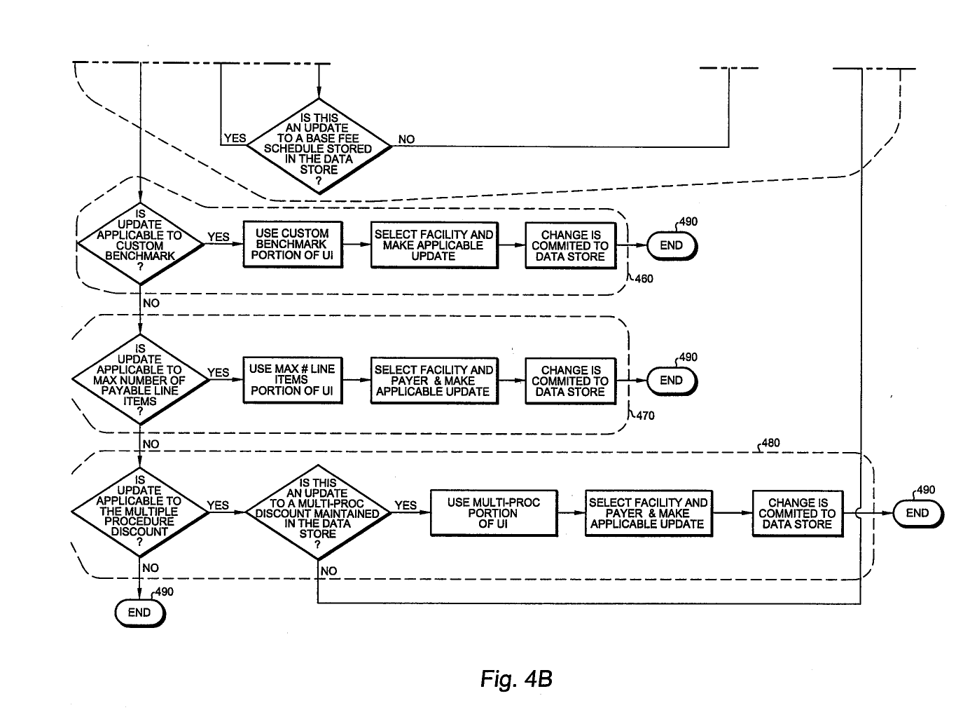

FIG. 4 displays a process by which a user may interact with the auditing process of the present invention to insert, update, or delete values stored in one of the price models represented in the invention and held in the invention's data store. According to one embodiment of the present invention, a systematic payment audit uses a total of seven price models in the pricing evaluations; of these seven price models, one is stored in the facility management module (and is transferred to the processing center via the data export/import process), one is the system default benchmark price (which is not user-editable), and the remaining 6 price models are all maintained in the data store. These seven price models are configurable through the user interface. As will be recognized by one skilled in the relevant art, the number of pricing models is not definitive and indeed any number of pricing models can be analyzed by the present invention. Embodiments of the present invention take into account any price information that has been entered and stored in the Facility Management Software. During the price evaluation and assignment portion of the systematic audit payment processing, this price model is purposely applied after the price models that are stored in the invention's data store. The order of price model application enables users to override pricing stored in various data locations by inserting a price higher in the price model evaluation process. This allows for considerable flexibility in the application of the most accurate price possible during the systematic audit payment processing.

According to one aspect of the present invention, a user can edit the price models when an update has been identified. As an initial step, new or updated price data is received 410 indicating that one or more pricing models should be updated. The first user decision relates to determining 415 where the stored price model data resides. If the stored price model data resides in the facility management module, then the user must use that software to update the stored price and the price update process ends. It should be noted that facility management module packages are generally capable of storing a single type of price model (comparable to the Per Code Pricing in the present embodiment of the invention). If the update is to be applied to a price model that is stored in the invention's data store, then the user advances to the next decision. Nonetheless, the price model associated with the newly received data is identified. Thereafter the updated price data is incorporated into the existing price model and, if necessary, a new audit of payment information is initiated. In the paragraphs that follow, updates to the different price models are discussed.

If the update is to be applied to a case rate 420, then the user will engage the case rate portion of the user interface in order to apply the update to the case rate price model. The user must select a facility and insurance company pertinent to the update. Applicable to the update, the user must enter (or select) the code to which the case rate will be assigned. The user can then designate the appropriate price and effective date. The effective date is used during the systematic audit payment processing to properly assign a case rate price only after the date in which that price became effective according to the contract or payment agreement with the government payer or private insurance company. When a new record is entered by a user, the effective date can be set to any date and no previous price will be assigned as a case rate amount for that code. When a record is updated by a user, the effective date can be set to any date, and the previously stored payment amount will be applied to dates prior to the effective date whereas dates falling on or after the effective date will use the new case rate amount. This allows users to store two effective prices: one price that was in effect in a previous contract or payment agreement, and one price that is currently in effect in the current contract or payment agreement. This dual-price model for case rates allows the systematic payment audit to analyze payment amounts accurately both before and after a new contract or payment agreement (with corresponding new payment rates) goes into effect. Either a new data record or an update to an existing data record is then committed to permanent memory in the invention's data store. Additionally, a user can delete a case rate price, which will take effect immediately. If the update is not applicable to a case rate price, the user advances to the next decision.

When the update is to be applied to a per code price 430, then the user will engage the per code price portion of the user interface in order to apply the update to the per code price model. The user selects a facility and insurance company pertinent to the update. Applicable to the update, the user must enter (or select) the code to which the per code price will be assigned. The user can then designate the appropriate price and effective date. The effective date is used during the systematic audit payment processing to properly assign a per code price only after the date in which that price became effective according to the contract or payment agreement with the government payer or private insurance company. When a new record is entered by a user, the effective date can be set to any date and no previous price will be assigned as a per code price amount for that code. When a record is updated by a user, the effective date can be set to any date, and the previously stored payment amount will be applied to dates prior to the effective date whereas dates falling on or after the effective date will use the new per code price amount. This allows users to store two effective prices: one price that was in effect in a previous contract or payment agreement, and one price that is currently in effect in the current contract or payment agreement. This dual-price model for per code prices allows the systematic payment audit to analyze payment amounts accurately both before and after a new contract or payment agreement (with corresponding new payment rates) goes into effect. Either a new data record or an update to an existing data record is then committed to permanent memory in the invention's data store. Additionally, a user can delete a per code price, which will take effect immediately. If the update is not applicable to a per code price, the user advances to the next decision.

A percentage of charge price update 410 (for a specific code) can be accomplished by engaging the percent of charge price (for a specific code) portion of the user interface. The user selects a facility and insurance company pertinent to the update. Applicable to the update, the user enters (or selects) the code to which the percent of charge price will be assigned. The user can then designate the appropriate price and effective date. The effective date is used during the systematic audit payment processing to properly assign a percent of charge price (for a specific code) only after the date in which that price became effective according to the contract or payment agreement with the government payer or private insurance company. When a new record is entered by a user, the effective date can be set to any date and no previous price will be assigned as a percent of charge price amount for that code. When a record is updated by a user, the effective date can be set to any date, and the previously stored payment amount will be applied to dates prior to the effective date whereas dates falling on or after the effective date will use the new percent of charge price amount. This allows users to store two effective prices: one price that was in effect in a previous contract or payment agreement, and one price that is currently in effect in the current contract or payment agreement. This dual-price model for percent of charge prices allows the systematic payment audit to analyze payment amounts accurately both before and after a new contract or payment agreement (with corresponding new payment rates) goes into effect. Either a new data record or an update to an existing data record is then committed to permanent memory in the invention's data store. Additionally, a user can delete a percent of charge price (for a specific code), which will take effect immediately. If the update is not applicable to a percent of charge price (for a specific code) price, the user advances to the next decision.

A linked fee schedule 450 can also be updated. First the user must decide what type of update shall be applied. Linked fee schedules are essentially a way to avoid the need to enter a redundant price model for an additional payer. The linked fee schedule concept allows a user to apply a price model that has been previously entered to an additional insurance company. The linked fee schedule vernacular includes two key aspects: the base fee schedule and the linked fee schedule. The base fee schedule (price model) is the one which has been entered previously, and the linked fee schedule is the payer to which the base fee schedule will be applied. There are three possible types of base fee schedules: a per code price stored in the invention's data store, a per code price stored in the Facility Management Software, or the charge amount. Included as part of the linked fee schedule portion of the present embodiment of the invention is an “adjuster” amount (applied as a percentage) that is stored as part of the link between fee schedules. This adjuster allows further flexibility in the application of linked fee schedules, as a base fee schedule can be adjusted up or down (from 1% to 999%) when linked. For example, a contract for worker's compensation might be based on the state fee schedule; this contract might only allow 88% of the state fee schedule, however. The adjuster permits the user to enter the state fee schedule one time, and then link that base fee schedule to another payer using 88% of the price for each code. If the base fee schedule is the charge amount, then the adjuster will be applied to the charged amount similarly for any service billed to the linked payer.

When the update to be made is to the link itself (link the payer to a new base fee schedule or change the adjuster being used), then the user will engage the Linked Fee Schedule portion of the user interface. The user will select the type of base fee schedule (data store, Facility Management Software, or charge), then the base fee schedule. The user will then select the payer to be linked, enter the adjuster as applicable, then save the link. The link (including the base fee schedule, linked payer, and adjuster) will be committed to permanent memory in the data store.

When the base fee schedule used in the link is to be updated and the base fee schedule is stored in the data store, then the user will engage the per code price portion of the user interface in order to apply the update to the per code price model. In this case, the linked fee schedule will honor all of the per code pricing data, including effective dates. If the update to be made is to the base fee schedule used in the link and the base fee schedule is stored in the Facility Management Software, then the user must use that software to apply the update to the price.

When the update is to be applied to a custom benchmark price 460 the user will engage the custom benchmark portion of the user interface in order to apply the update to the custom benchmark price model. The user must select a facility pertinent to the update (no insurance company is required, as the custom benchmark pricing is set as the low-price mark for every time the specified code is billed and a more accurate price cannot be assigned). Applicable to the update, the user must select the code to which the custom benchmark will be assigned. Only codes that have been billed are eligible for a custom benchmark price, and effective dates are not applicable to custom benchmarks. Either a new data record or an update to an existing data record is then committed to permanent memory in the invention's data store. Additionally, a user can delete a custom benchmark, which will take effect immediately. If the update is not applicable to a custom benchmark price, the user advances to the next decision.

The designations of a maximum number of payable line items 470 can also be updated. In such an instance the user will engage the maximum number of line items portion of the user interface in order to apply the update. The user must select a facility and insurance company pertinent to the update. Applicable to the update, the user must enter the maximum number of payable line items. Line items on a single claim that exceed the maximum payable line items will not have a price assigned during the systematic payment audit. Either a new data record or an update to an existing data record is then committed to permanent memory in the invention's data store. Additionally, a user can delete a maximum number of payable line items for an insurance company, which will take effect immediately. If the update is not applicable to the maximum number of payable line items, the user advances to the next decision.

Finally when the update is to designate a custom multiple procedure discount amount 480 that is maintained in the invention's data store, then the user will engage the multiple procedure discount portion of the user interface in order to apply the update. The user must select a facility and insurance company pertinent to the update. Applicable to the update, the user must enter the multiple procedure discount amount (as a percentage). Line items on a single claim that are subject to multiple procedure discounting during the systematic payment audit will have their target prices adjusted according to this value. Either a new data record or an update to an existing data record is then committed to permanent memory in the invention's data store. Additionally, a user can delete a multiple procedure discount for an insurance company, which will take effect immediately. If the update is to designate a custom multiple procedure discount amount that is maintained in the Facility Management Software, then the user will engage the Facility Management Software in order to apply the update.

As can be seen in FIG. 4, the update process ends 490 upon recognition of the pertinent pricing model and making the appropriate modifications.

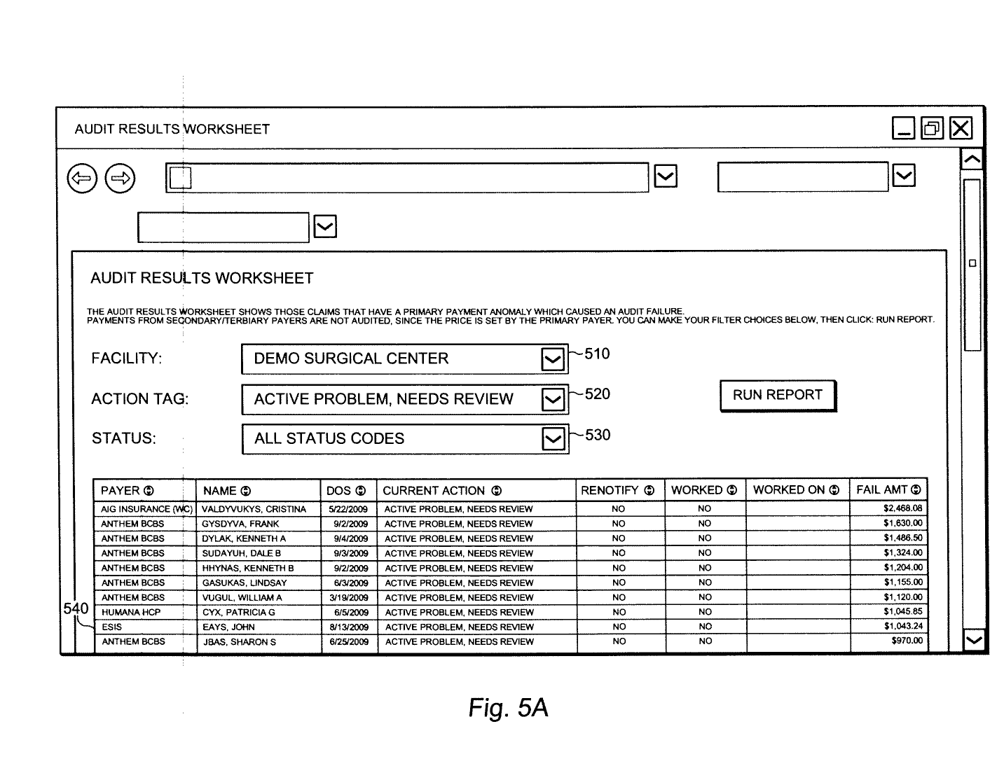

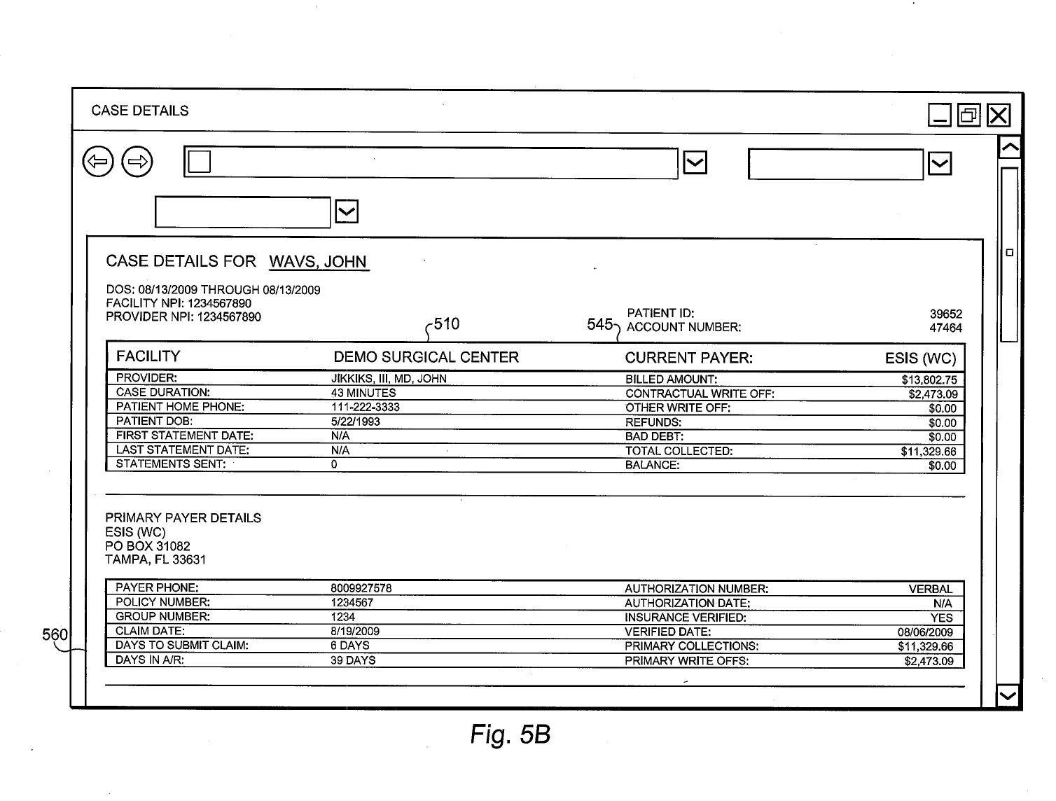

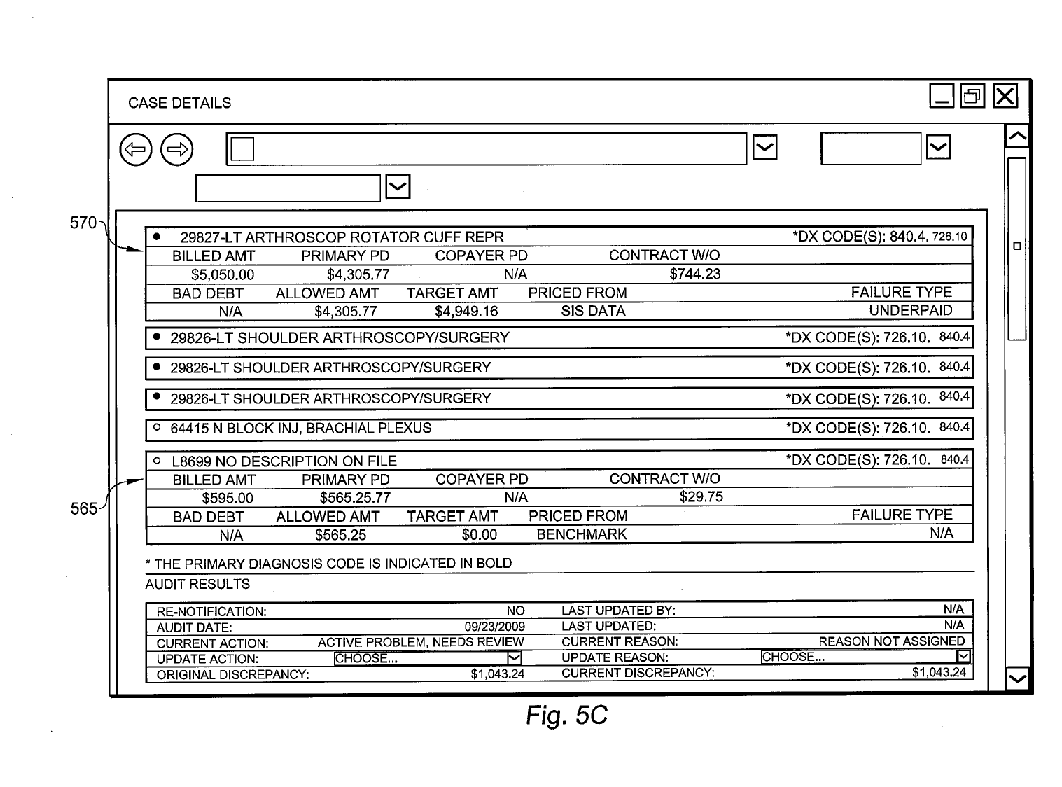

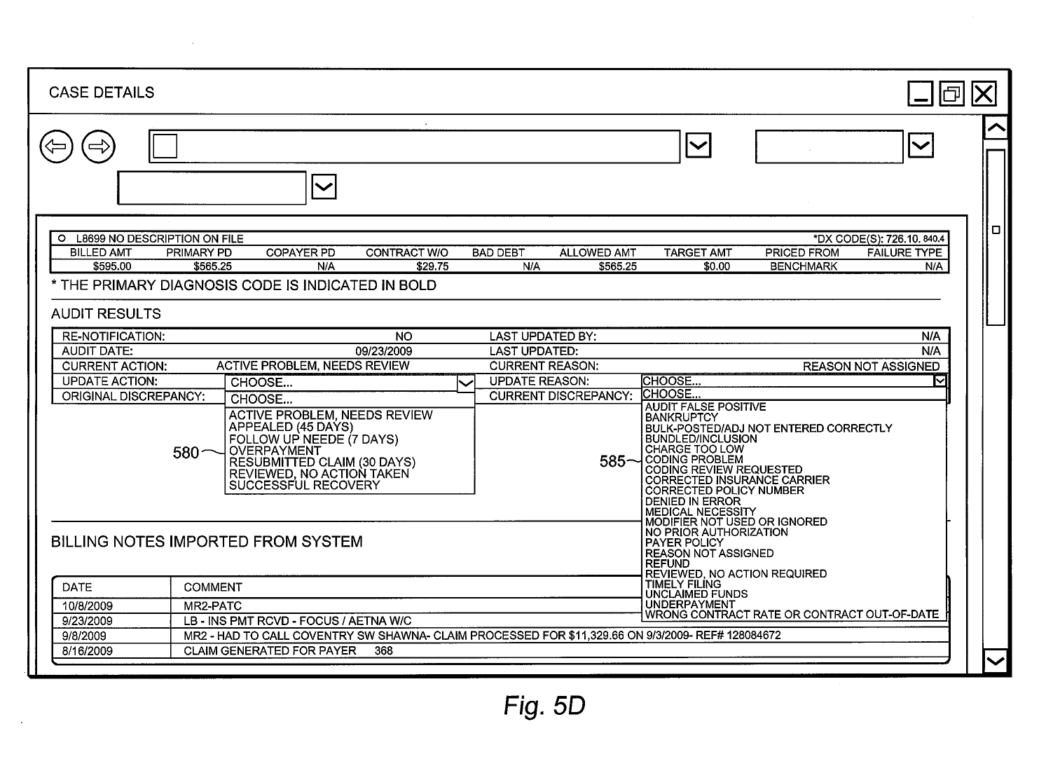

FIG. 5 comprises a plurality of screen shots showing one embodiment of a user interface for displaying and managing payment discrepancies identified through a payment audit system of the present invention. FIG. 5A shows a portion of an audit results worksheet generated from an audit analysis of payment information in pricing models received from a surgical center. As previously explained, payment data from a plurality of payers is received and stored in a facility management database. This payment information along with the plurality of pricing models is conveyed via the Internet to a data processing system of the present invention whereby an audit of the payments in comparison to the pricing models is conducted. Upon completion of the audit one or more payment discrepancies is identified. The audit results worksheet shown in FIG. 5A shows a portion of the plurality of payment discrepancies as identified by one embodiment of the present invention.

As shown, the present invention identifies a particular facility, in this case a demo surgical center 510 selected for analysis. Furthermore any problem that needs to be reviewed 520 and any status codes 530 are included in the audit results worksheet. As one skilled in the relevant art will appreciate the present invention enables a user using this interface to select a particular facility and filter various problems which the user wishes to review. Each line of the audit results worksheet includes payer information, the name of the patient associated with the claim, the date of the claim, and information with respect to the discrepancy.

Turning now in addition to FIG. 5B, specific details can be seen with respect to each patient's claim. In the examples used in FIG. 5B, a claim for patient John Ways is shown. This stream of the interface of the present invention identifies the facility as a demo surgical center 510 and the current payer 545. Additional details are also included in the report to aid in the verification of the claim.

Turning now to FIG. 5C, a more detailed illustration of the line items for this particular case 560 can be seen. In this particular claim, 6 line items were billed. They include arthroscopic rotor cuff repair, three line items for shoulder arthroscopic surgery, brachial plexus, and one line item for which no description is on file. As can be seen by reference back to FIG. 5B, the six line items were submitted for payment of a total of $13,802.75 of which $2473.09 was written off by the payer. However, according to the audit conducted by one embodiment of the present invention, there is a discrepancy between the payment amount offered by the payer and that which has been sought by the surgical center.

As can be seen on the left side of the billed item list in FIG. 5C, status indicators are used to identify failed or past payments. The red indicators identify payment discrepancies while the green indicator indicates a pass. The first line item for arthroscopic work of repair 560, billing code 29827 is flagged as possessing a payment discrepancy. In this case the surgical center billed $5050 worth of services of which the payer paid $4305.77. The payer has indicated that $744.23 is a contract write-off associated with this type of procedure. However, as one embodiment of the present invention has shown, the target amount for which the surgical center feels it should be reimbursed its $4949.16. The present invention identifies this discrepancy to the user for issue management.

This first payment discrepancy for arthroscopic rotor cuff repair 570 also can be compared to a service provided wherein there is no description on file 565. The last item 565 in the claim, line item L8699, was billed out to the payer for $595. For the service provided the payer compensated the surgical center for $565.25 indicating a write-off of $29.75. This allowed amount and write-off was found to correspond with the contractual agreement between the surgical center and the payer. Thus the target amount is indicated zero, or more accurately the target amount and the allowed amount are equal. And while this line item does not show a payment discrepancy, the invention has identified four instances of payment discrepancies for other line items in this claim and has highlighted this claim to the user for possible follow-up action.

FIG. 5D of the same screen shots identifies options for the user to manage the audit results. The audit results section not only provides data with respect to the payment discrepancy for this particular claim but also enables the user to identify what type of follow-up action 580 is warranted. According to one embodiment of the present invention, the user can maintain that a current discrepancy is an active problem which requires review, that the discrepancy has been appealed calling for a 45 day review, an additional follow-up is needed within 7 days, an overpayment condition exists, that the claim should be resubmitted, that the discrepancy has been reviewed and no action is to be taken or that a successful recovery has occurred. Furthermore a user can choose from a plurality of reasons why this particular action has been initiated 585. For example an auditor having identified a payment discrepancy and having reviewed the particular case file may elect to indicate that no action has been taken because of bankruptcy.

As can be seen by FIGS. 5A through 5D, the present invention provides useful information and the ability to manage payment discrepancies for a service rendering facility. By using the audit process described above and the interface shown in FIG. 5, a user is provided with a concise and complete list of payment discrepancies, differences between the payment amount offered by a payer and the amount claimed by a surgical center.

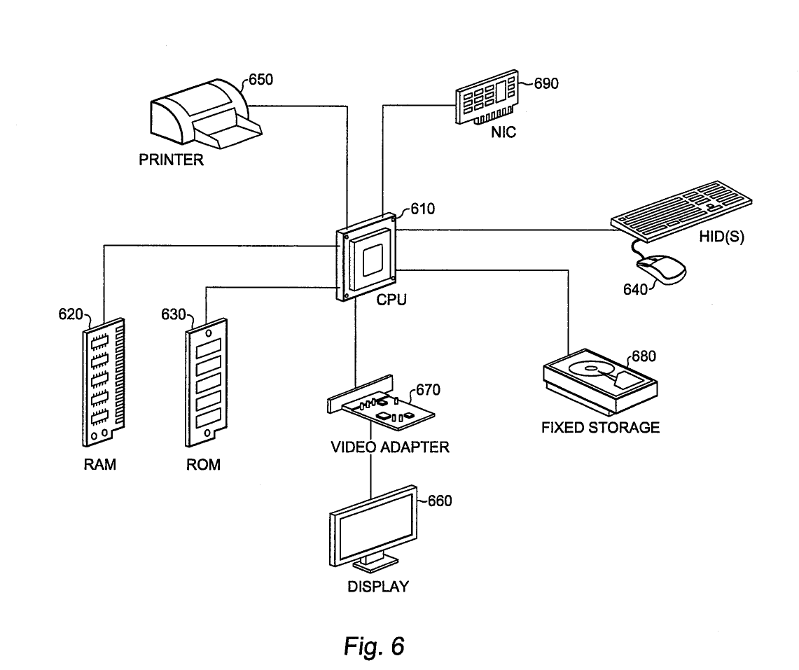

As will be appreciated by one skilled in the relevant art, the present invention may be implemented on a conventional or general-purpose computer system such as a personal computer (PC), a laptop computer, a notebook computer, a handheld or pocket computer, and/or a server computer. FIG. 6 is a very general block diagram of a computer system 600 in which a software-implemented processes of the present invention may be embodied. As shown, a system comprises a central processing unit(s) (CPU) 610 or processor(s) coupled to a random-access memory (RAM) 620, a read-only memory (ROM) 630, a keyboard 640, a printer 650, a pointing device, a display 660 or video adapter 670 connected to a display device 660, a removable (mass) storage device (e.g., floppy disk, CD-ROM, CD-R, CD-RW, DVD, or the like), a fixed (mass) storage device (e.g., hard disk) 680, a communication (COMM) port(s) or interface(s), and a network interface card (NIC) 690 or controller (e.g., Ethernet). Although not shown separately, a real time system clock is included with the system in a conventional manner.

The CPU 610 comprises a suitable processor for implementing the present invention. The CPU 610 communicates with other components of the system via a bi-directional system bus (including any necessary input/output (I/O) controller circuitry and other “glue” logic). The bus, which includes address lines for addressing system memory, provides data transfer between and among the various components. RAM serves as the working memory for the CPU. The ROM contains the basic input/output system code (BIOS)—a set of low-level routines in the ROM that application programs and the operating systems can use to interact with the hardware, including reading characters from the keyboard, outputting characters to printers, and so forth.

Mass storage devices provide persistent storage on fixed and removable media such as magnetic, optical, or magnetic-optical storage systems, flash memory, or any other available mass storage technology. The mass storage may be shared on a network, or it may be a dedicated mass storage. As shown in FIG. 6, fixed storage stores a code and data for directing the operation of the computer system including an operating system, user application programs, driver and other support files, as well as other data files of all sorts. Typically, the fixed storage serves as the main hard disk for the system.

In basic operation, program logic (including that which implements the methodology of the present invention described below) is loaded from the removable storage or fixed storage into the main (RAM) memory for execution by the CPU. During operation of the program logic, the system accepts user input from a keyboard and pointing device, as well as speech-based input from a voice recognition system (not shown). The keyboard permits selection of application programs, entry of keyboard-based input or data, and selection and manipulation of individual data objects displayed on the screen or display device. Likewise, the pointing device, such as a mouse, track ball, pen device, or the like, permits selection and manipulation of objects on the display device. In this manner, these input devices support manual user input for any process running on the system.

The computer system displays text and/or graphic images and other data on the display device. The video adapter, which is interposed between the display and the system's bus, drives the display device. The video adapter, which includes video memory accessible to the CPU, provides circuitry that converts pixel data stored in the video memory to a raster signal suitable for use by a cathode ray tube (CRT) raster or liquid crystal display (LCD) monitor. A hard copy of the displayed information, or other information within the system, may be obtained from the printer or other output device.

The system itself communicates with other devices (e.g., other computers) via the NIC connected to a network (e.g., Ethernet network, Bluetooth wireless network, or the like). The system may also communicate with local occasionally-connected devices (e.g., serial cable-linked devices) via the COMM interface, which may include a RS-232 serial port, a Universal Serial Bus (USB) interface, or the like. Devices that will be commonly connected locally to the interface include laptop computers, handheld organizers, digital cameras, and the like.

The computer system of FIG. 6 can also be employed in a network setting such as a local area network or wide area network and the like. Such networks may also include mainframe computers or servers, such as a gateway computer or application server (which may access a data repository or other memory source). A gateway computer serves as a point of entry into each network. The gateway may be coupled to another network by means of a communication link. Further, the gateway computer may be indirectly coupled to one or more devices. The gateway computer may also be coupled to a storage device (such as a data repository). The gateway computer may be implemented utilizing a variety of architectures.

Those skilled in the art will appreciate that the gateway computer may be located a great geographic distance from the network, and similarly, the devices may be located a substantial distance from the networks as well. For example, the network may be located in California while the gateway may be located in Texas, and one or more of the devices may be located in New York. The devices may connect to the wireless network using a networking protocol such as the TCP/IP over a number of alternative connection media such as cellular phone, radio frequency networks, satellite networks, etc. The wireless network preferably connects to the gateway using a network connection such as TCP or UDP (User Datagram Protocol) over IP, X.25, Frame Relay, ISDN (Integrated Services Digital Network), PSTN (Public Switched Telephone Network), etc. The devices may alternatively connect directly to the gateway using dial connection. Further, the wireless network may connect to one or more other networks (not shown) in an analogous manner.

In preferred embodiments, the present invention is implemented in software. Software programming code that embodies the present invention is typically accessed by the microprocessor from long-term storage media of some type, such as a hard drive. The software programming code may be embodied on any of a variety of known media for use with a data processing system such as a hard drive or CD-ROM. The code may be distributed on such media, or may be distributed from the memory or storage of one computer system over a network of some type to other computer systems for use by such other systems. Alternatively, the programming code may be embodied in the memory and accessed by the microprocessor using the bus. The techniques and methods for embodying software programming code in memory, on physical media, and/or distributing software code via networks are well known and will not be further discussed herein. An implementation of the present invention may be executing in a Web environment, where software installation packages are downloaded using a protocol such as the HyperText Transfer Protocol (HTTP) from a Web server to one or more target computers which are connected through the Internet. Alternatively, an implementation of the present invention may be executed in other non-Web networking environments (using the Internet, a corporate intranet or extranet, or any other network) where software packages are distributed for installation using techniques such as Remote Method Invocation (RMI) or Common Object Request Broker Architecture (CORBA). Configurations for the environment include a client/server network as well as a multi-tier environment. Or, as stated above, the present invention may be used in a stand-alone environment, such as by an installer who wishes to install a software package from a locally-available installation media rather than across a network connection. Furthermore, it may happen that the client and server of a particular installation both reside in the same physical device, in which case a network connection is not required. Thus, a potential target system being interrogated may be the local device on which an implementation of the present invention is implemented. A software developer or software installer who prepares a software package for installation using the present invention may use a network-connected workstation, a stand-alone workstation, or any other similar computing device. These environments and configurations are well known in the art.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts, and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language or for any specific operation system or environment. Accordingly, the disclosure of the present invention is intended to be illustrative but not limiting of the scope of the invention which is set forth in the following claims. While there have been described above the principles of the present invention in conjunction with medical billing collection amounts, it is to be clearly understood that the foregoing description is made only by way of example and not as a limitation to the scope of the invention. Particularly, it is recognized that the teachings of the foregoing disclosure will suggest other modifications to those person skilled in the relevant art. Such modifications may involve other features that are already known per se and which may be used instead of or in addition to features that are already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A computer system for medical payment analysis, the computer system comprising:
a machine capable of executing instructions embodied as software; and
a plurality of software portions stored on a first memory coupled to the machine, wherein
one of said software portions is configured to store in a second memory a plurality of payment amounts received from a facility wherein each payment amount is associated with a claim and wherein each claim includes at least one billing code,
one of said software portions is configured to validate a plurality of pricing models stored in the first memory,
one of said software portions is configured to retrieve from the first memory the plurality of pricing models and to retrieve from the second memory the plurality of payment amounts,
one of said software portions is configured to associate each of the plurality of payment amounts with one of the plurality of pricing models based on the claim submitted by the facility and the at least one billing code,
one of said software portions is configured to associate a target amount for the at least one billing code based on the associated pricing model, and
one of said software portions is configured to compare the associated target amount to each payment amount to identify a payment discrepancy and wherein responsive to identifying the payment discrepancy, identifying the payment amount as a failed claim to an end user.

2. The computer system of claim 1 wherein each of the plurality of pricing models is associated the at least one billing code.

3. The computer system of claim 2 wherein the at least one billing code and its associated target amount is uniquely associated to a payer.

4. The computer system of claim 3 wherein the payer is an insurance company.

5. The computer system of claim 3 wherein the payer is a government agency.

6. The computer system of claim 1 wherein the pricing model is associated with a payer.

7. The computer system of claim 1 wherein the target amount is associated with the at least one billing code.

8. The computer system of claim 7 wherein, responsive to the target amount failing to be associated with the billing code, assigning an average target amount based on the associated pricing model.

9. The computer system of claim 1 wherein responsive to the payment amount matching the target amount, identifying the payment amount as a passing claim to the end user via a user interface.

10. The computer system of claim 1 further comprising a software portion configured to identify a reason for the payment discrepancies.

11. The computer system of claim 10 wherein the reason for the payment discrepancy is stored in a third memory.

12. The computer system of claim 10 further comprising a software portion configured to identify the reason for the payment discrepancy as based on billing code sequencing.

13. The computer system of claim 10 further comprising a software portion configured to identify the reason for the payment discrepancy as based on mutually exclusive billing code coding policies of the pricing model.

14. The computer system of claim 10 further comprising a software portion configured to identify the reason for the payment discrepancy as based on payers limiting a number of maximum payable billing codes submitted on a claim.

15. The computer system of claim 1 further comprising a software portion configured to modify claim submittal procedures based on the payment discrepancy.

16. The computer system of claim 1 further comprising a software portion configured to update in the first memory the associated pricing model based on the payment discrepancy stored in the third memory.

17. A computer-readable storage medium tangibly embodying a program of instructions executable by a machine wherein said program of instructions comprises a plurality of program codes for identifying discrepancies in payment amounts for billed services, said program of instructions comprising:
program code for recording in a first memory a plurality of received payments wherein each received payment is associated with at least one payment claim and wherein the at last one payment claim is associated with at least one payment billing code;
program code for accessing from a second memory a plurality of pricing models wherein each pricing model is associated with a plurality of claim billing codes and wherein each claim billing code is associated with a target payment;
program code for associating each of the plurality of received payments with one of the plurality of pricing models based on matching at least one claim billing code associated with one of the pricing models with at least one payment billing code associated with the at least one payment claim;
program code for determining the target payment based on the corresponding matched at least one claim billing code;
program code for comparing the received payment with the target payment associated with the matched at least one claim billing code wherein responsive to the received payment failing to match the target payment identifying a payment discrepancy; and
program code for determining whether the payment discrepancy is justified or unjustified wherein responsive to determining that the payment discrepancy is unjustified, adding the payment discrepancy to a list of payment discrepancies, and wherein responsive to identifying the payment discrepancy is justified, updating the pricing model in the second memory including the claim billing codes and the target payments.

18. A computer-readable storage medium tangibly embodying the program of instructions of claim 17 wherein program code for determining is further configured to determine whether the payment discrepancy is caused by a billing code segueing discrepancy.

19. A computer-readable storage medium tangibly embodying the program of instructions of claim 17 wherein determining whether the payment discrepancy is caused by a bundling policy violation.

20. A computer-readable storage medium tangibly embodying the program of instructions of claim 17 wherein determining whether the payment discrepancy is caused by a charge amount violation.

21. A computer-readable storage medium tangibly embodying the program of instructions of claim 17 wherein determining whether the payment discrepancy is caused by a billing code mutually exclusive policy violation.

22. A computer-readable storage medium tangibly embodying the program of instructions of claim 17 wherein determining whether the payment discrepancy is caused by a payer-instituted limit on a maximum number of payable billing codes on a claim for rendered services.

23. A computer-readable storage medium tangibly embodying the program of instructions of claim 17 wherein correcting the payment discrepancy includes submitting a revised claim to the payer.

24. A computer-readable storage medium tangibly embodying the program of instructions of claim 17 wherein correcting the payment discrepancy includes initiating an appeal process.

25. A computer implemented method for identifying discrepancies in payment amounts received for billed services, the method comprising:
receiving from a facility a plurality of payment amounts for services rendered wherein each payment amount is associated with a claim and at least one payment billing code;
storing the plurality of payment amounts in a first memory;
retrieving from the facility and storing in a second memory a plurality of pricing models wherein each pricing model includes a plurality of claim billing codes and wherein each claim billing code is associated with a target payment;
associating by a microprocessor coupled to the first and second memory each of the plurality of payment amounts with one of the plurality of pricing models based on the claim and the at least one payment billing code associated with the payment amount as compared to the claim billing codes of the pricing models;
assigning in the first memory a target amount for each payment amount based on the associated pricing model;
comparing in the first memory the associated target amount with each payment amount and identifying at least one payment discrepancy when the associated target amount fails to match the payment amount;
determining whether the at least one payment discrepancy is justified; and
responsive to determining that the payment discrepancy is not justified, identifying a course of action to correct the payment discrepancy.

26. The method of claim 25 further comprising creating a list of claims having payment discrepancies.

27. The method of claim 25 wherein responsive to determining that the payment discrepancy is justified updating the associated pricing model based on the payment billing code and payment amount.

28. The method of claim 25 wherein the revised claim and the payment discrepancy are stored in a third memory.
